(19) United States
(12) Patent Application Publication
(10) Pub. No.: US 2026/0100096 A1
(43) Pub. Date: Apr. 9, 2026

(54) AUTOMATED MANDATORY ACCOUNT-BASED GAMING TABLE SYSTEM

(71) Applicant: LNW Gaming, Inc., Las Vegas, NV (US)

(72) Inventors: Jon Christian WOLFE, Las Vegas, NV (US); Naveen MAHENDRAN, Chennai (IN); Skylar CAMPBELL, Henderson, NV (US); Wesley NALL, Olive Branch, MS (US); Murali VENKATARAMAN, Cumming, GA (US); Bhuvaneshwari MURALIDHARAN, Virudhunagar (IN); Nethaji Chandra Babu CHANDRASEKAR, Chennai (IN); Ananth Shanmuga SUNDARAM, Ariyalur (IN)

(21) Appl. No.: 19/351,366

(22) Filed: Oct. 7, 2025

Related U.S. Application Data
(60) Provisional application No. 63/704,953, filed on Oct. 8, 2024.

(51) Int. Cl. G07F 17/32; G06Q 20/36; G06Q 50/34

(52) U.S. Cl. CPC G07F 17/3239; G06Q 20/363; G06Q 50/34; G07F 17/3211; G07F 17/3269

(57) ABSTRACT

A system and method(s) to perform operations that include performing, based on user input via a player interface device, a mandatory account-based login at a gaming table. The operations further include tracking, by the processor, player activity. The operations further include detecting, based on the tracked player activity, that a threshold is exceeded for a responsible gaming restriction. The operations further include automatically modifying a gaming state at the gaming table for a given period. The operations further include indicating, via the player interface device, a progressing status associated with the given period. The operations further include restoring the gaming state in response to expiration of the given period.

### RELATED APPLICATIONS

This patent application claims priority benefit to U.S. Provisional Patent Application No. 63/704,953 filed Oct. 8, 2024, the disclosure of which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2025, LNW Gaming, Inc.

### FIELD

The present disclosure relates generally to system(s) and method(s) for managing responsible gaming restrictions in association with casino devices.

### BACKGROUND

Wagering game apparatus, such as gaming tables, slot machines, video poker machines and the like, have been a cornerstone of the gaming industry for several years. Generally, the popularity of such apparatus depends on the likelihood (or perceived likelihood) of winning money at the apparatus and the intrinsic entertainment value of the apparatus relative to other available gaming options. Where the available gaming options include a number of competing wagering game apparatus and the expectation of winning at each apparatus is roughly the same (or believed to be the same), players are likely to be attracted to the most entertaining and exciting apparatus as well as those apparatus, or systems, that are easy to use.

Furthermore, there exist some challenges in developing games that present the most entertaining and exciting artwork, features, etc. For example, as games get more advanced, the designed gaming content increases in resolution and detail, thus also increasing in size and complexity. Therefore, animation of conventional gaming content can require improved or upgraded hardware (e.g., memory, graphics processing units, etc.) used to store, process, present, etc. the large and complex gaming content.

In addition, while the gaming industry attempts to provide the best possible experience for a gamer, the gaming industry has a responsibility to promote responsible gaming. To that end, some gaming systems provide some opportunities for gamers to set limits regarding spending or enact self-imposed restrictions. However, these self-imposed restrictions can be easily circumvented or remain unused.

Therefore, there is a continuing need for wagering game apparatus manufacturers to continuously develop gaming features (e.g., innovative and/or interesting gaming content) that will improve the gaming experience for players as well as to improve responsible gaming. Furthermore, it would be beneficial to have an apparatus that overcomes the conventional technical challenges and complexities associated with developing and animating ever more sophisticated gaming content, while also monitoring and managing responsible gaming via gaming networks, systems, devices, etc.

### SUMMARY

According to an embodiment of the present disclosure, a system and/or method(s) to perform operations that include performing, based on user input associated with a player interface device at a player station of a gaming table, a mandatory login of a player account. The mandatory login initiates a gaming session for the player account at the player station. The operations further include tracking, by the processor, player activity, wherein at least a portion of the player activity occurs during the gaming session. The operations further include detecting, based on the tracked player activity, that a threshold is exceeded for a responsible gaming restriction. The operations further include automatically modifying, based on the exceeded threshold, one or more gaming states at the gaming table for a given period. The operations further include indicating, via the player interface device, a progressing status associated with the given period. The operations further include restoring, in response to expiration of the given period, the one or more gaming states.

According to an embodiment of the present disclosure, an apparatus having memory and a processor. The memory stores instructions. The processor is configured to execute the instructions to perform operations to: track player activity associated with a player account during a gaming session; input the tracked player activity into a machine learning model; receive, from the machine learning model, a player segmentation label based on a detected player risk behavior; and trigger a personalized intervention strategy corresponding to the player segmentation label.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example network according to one or more embodiments of the present disclosure.

FIG. 2 is a diagram of an architecture according to one or more embodiments of the present disclosure.

FIG. 3 is a schematic view of a gaming system according to one or more embodiments of the present disclosure.

FIG. 4 is a diagram of a computer system according to one or more embodiments of the present disclosure.

FIG. 5 illustrates an example gaming table system according to one or more embodiments of the present disclosure.

FIG. 6A illustrates an example player interface device interaction with a mobile device in association with responsible gaming according to one or more embodiments of the present disclosure.

FIG. 6B illustrates an exploded view of a player interface device for a gaming table according to one or more embodiments of the present disclosure.

FIG. 6C illustrates an example player interface device for a gaming table according to one or more embodiments of the present disclosure.

FIG. 7 illustrates an example method flow of managing an automated mandatory account-based gaming system according to one or more embodiments of the present disclosure.

FIG. 8A and FIG. 8B illustrate examples of managing responsible gaming restrictions associated with a gaming machine according to one or more embodiments of the present disclosure.

FIG. 9A, FIG. 9B, FIG. 9C, and FIG. 9D illustrate examples of tracking a responsible gaming status associated with a player interface device at a gaming table according to one or more embodiments of the present disclosure.

FIG. 10 through FIG. 27 illustrate example method flows according to one or more embodiments of the present disclosure.

FIG. 28 through FIG. 36 illustrate various screens associated with managing responsible gaming limit tracking according one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

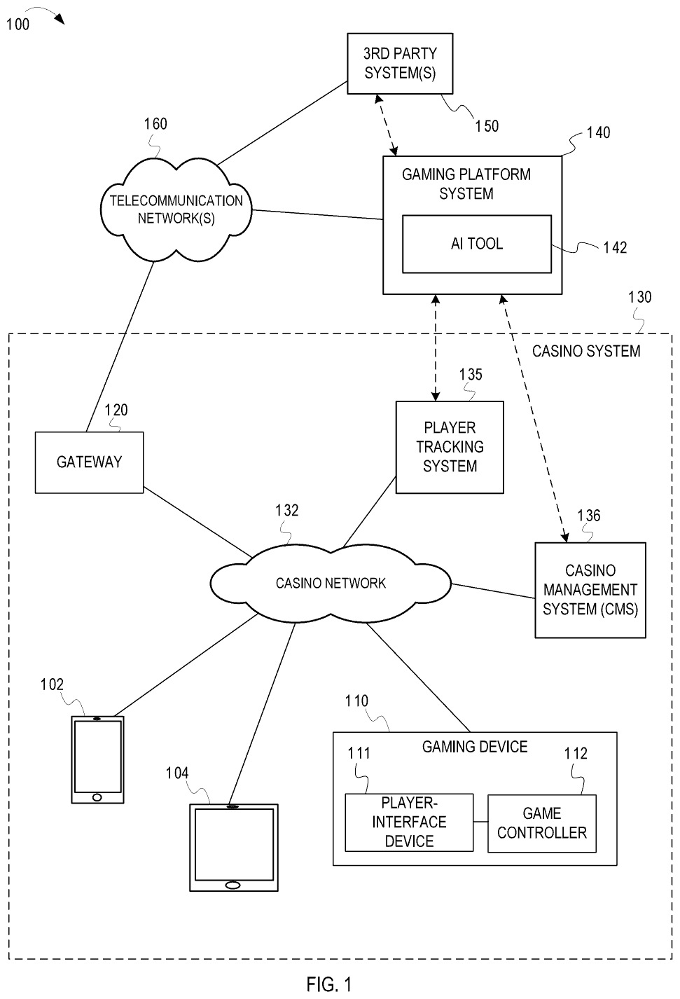

FIG. 1 is a diagram of an example network (“network 100”) according to one or more embodiments of the present disclosure. The network 100 includes a gaming platform system 140 communicatively coupled (e.g., connected within the network 100) to additional systems and/or devices via one or more telecommunication networks (i.e., “telecommunication network(s) 160”) and via a local casino network 132. In some embodiments, the telecommunication network(s) 160 include, but are not limited to, the Internet, a computer network, a cell phone communication network, etc. In one embodiment, the gaming platform system 140 is a global platform. A global platform provides a scalable, unified infrastructure that enables cross-border interactions, worldwide accessibility, standardized experiences, integration of diverse services or applications, etc. In another embodiment, the gaming platform system 140 is a data platform. A data platform is an integrated set of technologies that enables acquisition, storage, preparation, delivery, and governance of data, as well as a security layer for users and applications. In another embodiment, the gaming platform system is a unified global data platform, which combines aspects of a global platform and a data platform. In yet another embodiment, the gaming platform system 140 incorporates an AI automation tool (e.g., AI tool 142) (e.g., associated with an automated machine learning platform and/or a data platform system). An example of one or more AI automation tools used in association with one or more gaming systems, networks, etc. are described in U.S. Provisional Patent Application Ser. No. 63,597,851 filed Nov. 11, 2023 (“63,597,851 Application”) and/or in U.S. patent application Ser. No. 18,794,858 filed Aug. 5, 2024 (“18,794,858 Application”), which 63,597,851 Application and 18,794,858 Application are each incorporated by reference herein in their respective entireties.

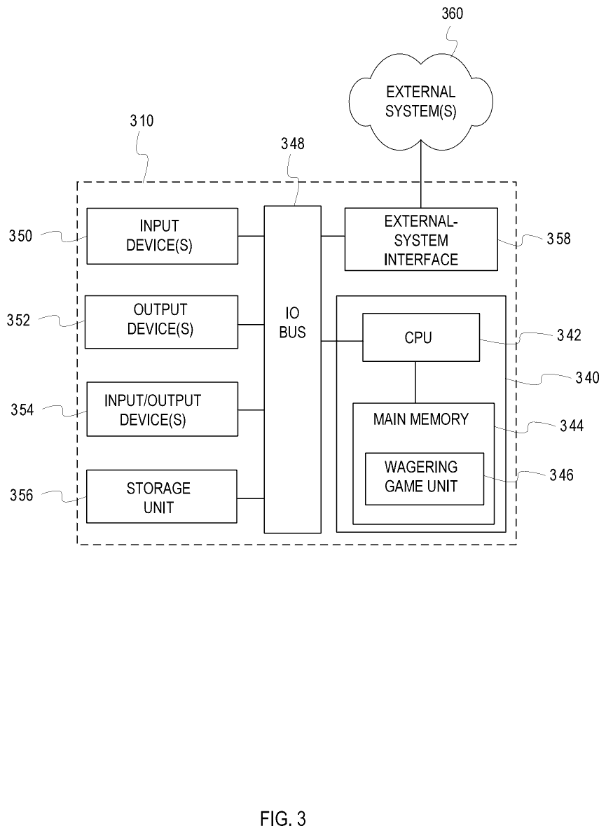

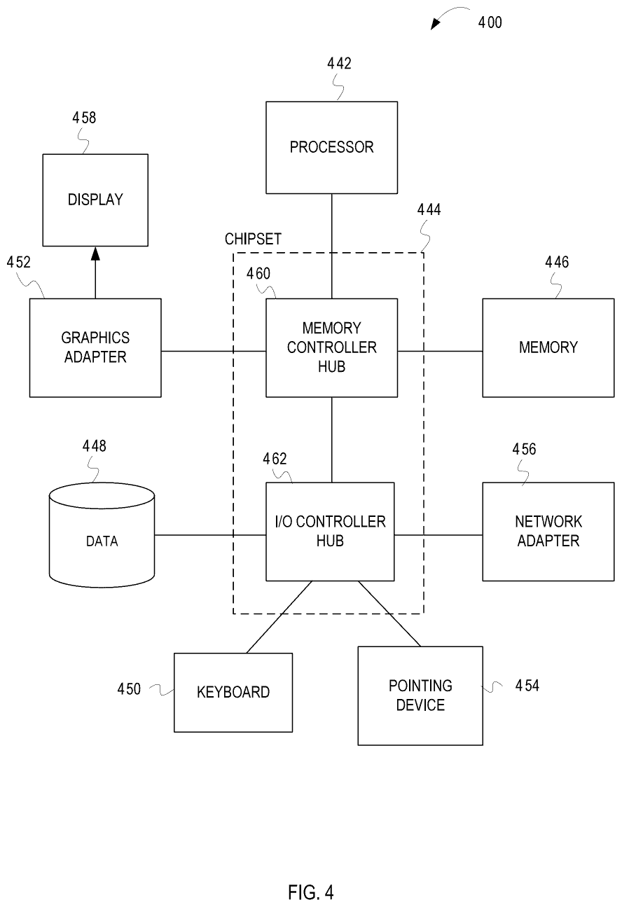

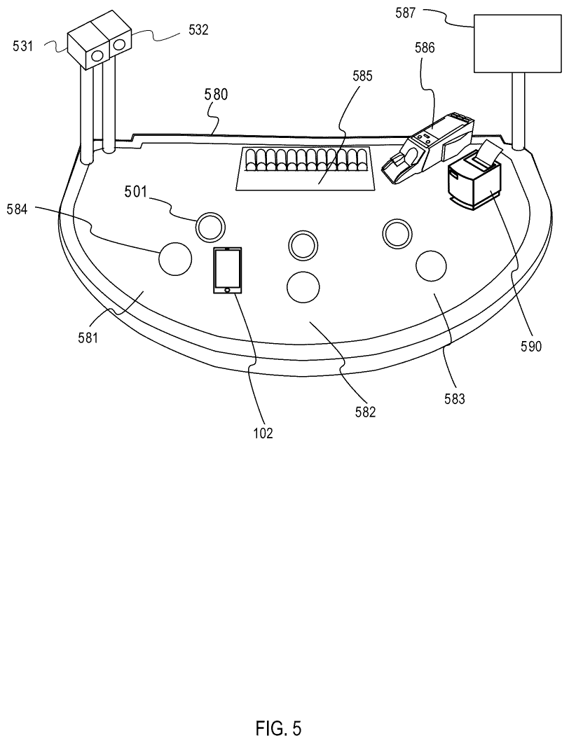

In one embodiment, one of the additional systems or devices communicatively coupled to the gaming platform system 140 includes a casino system 130. In one embodiment, the casino system 130 includes a gateway 120 (e.g., a demilitarized zone (DMZ) Server) gateway communicatively coupled via a gaming network, (e.g., via casino network 132)) to a player tracking system 135, which is communicatively coupled to a gaming device 110. The gateway 120 may be a server, a desktop computer, a laptop, a smartphone, a gaming machine, or other form of electronic device having one or more processors, a computer memory, an electronic communications system (e.g., a bus, a network interface device, a wireless communications device, etc.), etc. For instance, gateway 120 may be computer system 400 described in FIG. 4. The gaming device 110 includes player interface device 111 and game controller 112. One example of a gaming device 110 is gaming machine 310 described in FIG. 3. Another example of a gaming device 110 is a gaming table 580 described in FIG. 5. In one example, player interface device 111 may connect to, or be associated with, input/output device(s) 254 and/or external-system interface 258. In another example, player interface device 111 may be player interface device 501 associated with gaming table 580. Game controller 112 may be incorporated with game-logic circuitry 240. Presentation device(s) 114 may be connected to, or associated with, output device(s) 252 and/or input/output devices 254 (e.g., for touch-screen devices). One example of the player interface device 111 includes an iView® player interface device manufactured by Light & Wonder, Inc. The player interface device 111 may be communicatively connected to the gaming device 110 (e.g., connected via Universal Serial Bus (USB) connection). An example description of the iView® player interface device can be found in United States (U.S.) U.S. Pat. No. 8,241,123 to Kelly et al., the entirety of which is hereby incorporated by reference.

Player tracking system 135 is authorized to perform transactions with, and/or to securely communicate with, player interface device 111. In some embodiments, some combination of one or more of player interface device 111, player tracking system 135, gateway 120, and/or one or more data storage devices (e.g., local database(s)) may also be collectively referred to as a “player tracking system,” a “patron management system,” a “player tracking application server,” etc., or more generally as, or part of, the casino system 130. In some embodiments, the player tracking system 135 refers to a casino player tracking system (CPTS) or player-centric casino marketing system that provides one or more of, but not limited to, player data collection and analysis, player segmentation and targeting, loyalty program management, personalized marketing and promotions, player tracking and analytics, customer relationship management (CRM), etc. An example of the player tracking system 135 is the CMP® player-tracking product and/or the Elite Bonusing Suite® marketing product, both available by Light & Wonder, Inc. In some embodiments, the player tracking system integrates with a casino management system (CMS) 136. The CMS 136 provides (via player interface device 111) “system-based content” and/or “system-based services.” System-based content and/or system-based services may include, but are not necessarily limited to, content related to player benefits, casino services, marketing bonuses, promotions, advertisements, beverage or dining services, or any other information that is relevant to the player's gaming experience other than the wagering game itself. Content for a wagering game may be referred to as game content. Game content, for instance, includes game assets of the wagering game, content related to a bet placed on the game (e.g., bet meters, pay tables, payout/collection, credit meters, number of lines selected for betting, an amount bet per line, a maximum bet, etc.), game play elements of the game (e.g., reels, indicia, game symbols,), game instructions, etc. The term “gaming content,” as used herein, comprises both system-based content and game content. Examples of the CMS 136 include, but are not limited to, one or more of the ACSC Casino Management System® product, the SDS® slot-management product, the Bally Unified Wallet® product, all available from Light & Wonder, Inc. In some embodiments, the player tracking system 135 can be incorporated into the CMS 136.

In one embodiment, the casino system 130 includes a gaming data aggregator configured to aggregate data from various sources and/or to organize data obtained from the sources. In one embodiment, the gaming data aggregator obtains gaming data from one or more databases associated with the casino system 130 (e.g., database(s) which stores data related to players (e.g., stored in SQL or other relational type database). In one embodiment, the data is injected into a machine learning (ML) model associated with AI tool 142.

The network 100 also includes one or more user computing devices associated with the casino system 130, such as mobile devices 102 and/or 104, used respectively by a player and/or a casino employee (e.g., mobile device 102 may be referred to herein as a player mobile device, mobile device 104 may be referred to herein as a casino employee mobile device). Mobile device 104 may be used by a dealer, or other operator employee, in connection with a table management system or application (e.g., table management system 204).

In one embodiment, AI tool 142 predicts, via an ML model using tracked data (e.g., aggregated data, real-time data, etc.), a user-specific output value (i.e., a predicted output value of the ML model) such as a predicted user behavior or pattern (e.g., a risk behavior, a play behavior, a bet behavior, etc.), a predicted user value or ranking, a predicted user state, etc. The network 100 further generates user-specific system-based content, such as customized content, information, instructions, intervention strategies, etc. related to the predicted, user-specific output value. The gaming platform system 140 further delivers the user-specific system-based content via a delivery mechanism associated with a location of the user (e.g., by a delivery mechanism that will most likely reach the attention of the user). For example, if the customized promotional offer is directed to a player (e.g., to a player associated with a player account) the network 100 provides via a presentation device most closely associated with the player, such as via a presentation device of player mobile device 102 and/or a presentation device associated with player interface device 111. If the user-specific system-based content is related to a casino employee, the user-specific system-based content can be sent to a presentation device at a casino employee station or to presentation device of casino employee mobile device 104.

Some embodiments described herein include mandatory account-based play (also referred to in some examples herein as mandatory carded play) via gaming device 110. The mandatory account-based play can present status indicators that show a progression of status related to tracked play period, regarding any responsible gaming restrictions, and/or regarding responsible gaming intervention strategies (e.g., a timer or tracker associated with a responsible gaming restriction or limit, a mandatory break-in-play status, etc.). In some embodiments, the status indicators can be color coded (or specified according to levels or degrees in other ways, such as via symbols, sounds, etc.). In an example where gaming device 110 is a gaming table (e.g., gaming table 580), each position (referred to as a “player station” or “player position”) at the gaming table can have a separate player interface device 111. The gaming device 110 is further configured to track player activity (e.g., in response to a mandatory account-based login) during a gaming session (e.g., at the gaming table 580, at the gaming machine 310). In some embodiments, the player activity is also tracked during one or more previous gaming sessions having a mandatory account-based login. In some embodiments, in response to detection of tracked player activity exceeding a threshold for a responsible gaming restriction (e.g., a time limit, a spending limit, etc.), the gaming device 110 can automatically initiate a responsible gaming response event, such as automatically modifying, based on an exceeded threshold, one or more gaming state during a specific period (i.e., a “modification period”). Some examples of modifying a gaming state include, but are not limited to, disabling a given gaming functionality, enforcing a mandatory break in play, preventing access to an account feature, enacting an intervention strategy, etc. The player interface device 111 associated with the gaming device 110 can indicate a status associated with the gaming restriction and/or the modification period, such as progressing status indicators presented on the player interface device 111 that show various levels of indicators (e.g., different colors) to indicate changes of status for the gaming state prior to, during, and or after the modification period. After the modification period expires (e.g., after the timing of the break in play ends), the modified gaming state(s) are restored (e.g., automatically re-enables a gaming function or process, provides messages to a dealer or pit boss to restore a gaming function or process, automatically permits game play to continue via the player account etc.). Thus, some embodiments provide technical solutions which improve a gaming device 110, such as by streamlining mandatory carded play monitoring, reducing dealer errors, increasing game flow, reducing player downtime, etc.

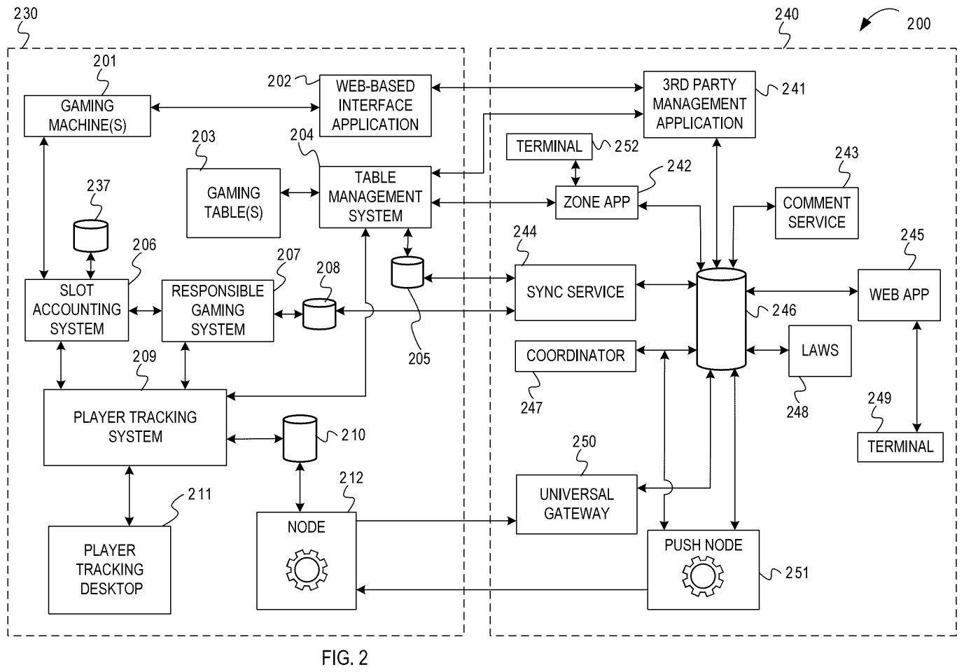

FIG. 2 is a diagram of architecture 200 according to one or more embodiments of the present disclosure. Architecture 200 includes casino system 230 (e.g., similar to casino system 130). For example, casino system 230 includes gaming machine(s) 201 and gaming table(s) 203 (e.g., similar to gaming machine 110). Further, casino system 230 includes player tracking system 209 (e.g., a server that incorporates and/or is connected to player tracking application, such as the CMP® player-tracking product (available from Light & Wonder, Inc), also referred to herein by the abbreviation “CMP”), which player tracking system 209 is similar to player tracking system 135. Database 210 is associated with the player tracking system 209. Furthermore, player tracking desktop 211 can be used to access and use (e.g., modify, configure, control, etc.) the player tracking system 209.

The architecture 200 further includes gaming platform system 240. In one embodiment, the global platform system 240 includes (e.g., incorporates, uses, comprises, etc.) the Engage™ global platform product (available from Light & Wonder, Inc) also referred to by the abbreviation “Engage” (e.g., in the context of one or more drawings of the present disclosure).

The architecture 200 further includes a third-party management application 241. The third-party management application 241 enables communication between devices in the casino system 230 and the gaming platform system 240, such as to store and/or access data associated with global platform database (i.e., database 246). Further, the third-party management application 241 utilizes representational state transfer (REST) application programming interfaces (APIs) for third party applications to use in their mobile, web or desktop applications. The third-party management application 241 can further provide monitoring and analytics capability to gain full visibility into API availability, traffic and usage trends as well as provide reports associated with performance metrics, usage trends which could be segmented further by client apps, APIs etc. One example of a third-party management application includes (e.g., incorporates, uses, comprises, etc.) the Envoy™ product (available from Light & Wonder, Inc.), which may be referred to herein by the abbreviation “Envoy” (e.g., in the context of one or more drawings of the present disclosure).

The architecture further includes a web-based interface application 202 (for communications between the third-party management application 241 and the gaming machine(s) 201) and a table management system 204 (for communications between the third-party management application 241 and the gaming table(s) 203). In one embodiment, the web-based interface application 202 can open and close ratings, process or access player data, configure gaming devices, etc. In one embodiment, the web-based interface application 202 includes (e.g., incorporates, uses, comprises, etc.) the iVISTA™ product (available from Light & Wonder, Inc.), also referred to herein by the abbreviation “iVISTA” (e.g., in the context of one or more drawings of the present disclosure).

In one embodiment, the table management system 204 can manage player ratings, provide secure access to financial data, can manage requests for chip fills and credits, can manage table closing, can issue comps and markers in real-time, can detect access to a player-based account (e.g., manages card-in and card-out), can track accumulation and enrollment, etc. associated with gaming table(s) 203. In one embodiment, the table management system 204 includes (e.g., incorporates, uses, comprises, etc.) the TableView™ product (available from Light & Wonder, Inc.), also referred to herein by the abbreviation “Table View” or “TV” (e.g., in the context of one or more drawings of the present disclosure). The table management system 204 communicates and synchronizes table-related information and/or user related data via synchronization service (e.g., sync service 244), which connects to database 246 for the gaming platform system 240.

The architecture 200 also includes slot accounting system 206. Database 237 is associated with slot accounting system 206. The slot accounting system 206 monitors gaming activity performed at gaming machine(s) 201. In some embodiments, the slot accounting system 206 includes (e.g., incorporates, uses, comprises, etc.) the SDS™ slot management system (available from Light & Wonder, Inc.), also referred to herein by the abbreviation “SDS,” and which functions according to the Slot Accounting System (SAS) protocol by International Game Technology PLC.

The architecture 200 also includes responsible gaming system 207. Database 208 is associated with the responsible gaming system 207. The responsible gaming system 207 provides tools for players to personalize and control gaming budgets, to set responsible gaming restrictions, etc. In one embodiment, the responsible gaming system 207 can refer to jurisdictional rules depending on a jurisdiction in which the casino system 230 is located, to enable the player to set the appropriate or allowable personal responsible gaming restrictions (e.g., limits in context of jurisdictional rules or laws pertaining to gaming and responsible gaming initiatives). For example, the player may use the responsible gaming system 207 to set limits that are more restrictive than required jurisdictional or other imposed restrictive limits. In one embodiment, the responsible gaming system 207 includes (e.g., incorporates, uses, comprises, etc.) the Pre-Commitment™ software product (available from Light & Wonder, Inc.), also referred to herein by the abbreviation “PC.” The responsible gaming system 207 communicates and synchronizes responsible gaming restrictions via the sync service 244. For example, the gaming platform system 240 can run the sync service 244 to fetch the responsible gaming configuration on the player level. All existing player-level configurations are synchronized to the gaming platform system 240, and any new enrollment information and/or responsible gaming changes further synchronize. In some instances herein, the term “responsible gaming” is abbreviated as “RG.”

The architecture 200 further includes a zone application (“zone app”) 242 to provide a user interface for a player to associate themselves to a gambling region (such as at a player station at a gaming table, at a given gaming machine, at a bank or group of gaming devices, a region or section of casino such as on a casino floor, etc.). In various embodiments, a player can associate themselves (e.g. login, check-in, etc.) via the zone app 242, in various ways, such by utilizing a swipe, a tap, etc. of a player loyalty card, by communicating (e.g., using near-field communication (NFC)) between a player mobile device and a player interface device (e.g., via player interface device 111, via player interface device 501, etc.), and so forth. The zone app 242 can further be used to enter a personal identification number (PIN) stored via the database 210 (which PIN is distributed by the player tracking system 209 to the gaming platform system 240 for used by the zone app 242 for player authentication. Further, in one embodiment, the zone application 242 can be accessed by terminal 252 (e.g., administrator terminal, desktop, etc.). In one embodiment, the zone app 242 uses Internet Information Services (IIS) via the Windows® Server product (available by Microsoft Corporation).

The architecture 200 further includes a coordinator 247 to perform health checks for the player tracking system 209 (and/or the player tracking system 135). The coordinator communicates with the database 246 and sends information to push node 251. The push node 251 pushes health check messages to the player tracking system 209. The push node 251 also pushes information associated with database 246 to node 212 to communicate to database 210. Node 212 further communicates information associated with database 210 to universal gateway 250. The universal gateway 250 receives all interactive/batch requests from the player tracking system 209. Comment service 243 synchronizes player notes from the player tracking system 209. Laws 248 is a device used to process all batch requests and publish messages to distribute. Web app 245 provides communications between database 246 and terminal 249 (e.g., administrator terminal, desktop, etc.). In one embodiment, the web app 245 uses IIS.

In some embodiments, the gaming platform system 240 implements and sends all responsible gaming parameters (e.g., responsible gaming restrictions, enrollment parameters, etc.) that are currently sent by to the web-based interface application 202 on login or access to the player account (e.g., “card in”). The web-based interface application 202 can then process the information and compute all the progress made towards the limits that are currently managed by a server or other device associated with the web-based interface application 202 and act on reaching thresholds of gaming restrictions (e.g., by modifying gaming states, by implementing an intervention strategy, etc. based on a level or type of detected player behavior, when a limit exceeds a threshold, etc.). The web-based interface application 202 can also send periodic updates to the gaming platform system 240 (based on periodic interval value received from the gaming platform system 240 on card in) with information on all computed values against the gaming restrictions.

FIG. 3 is schematic view of a gaming system according to at least some aspects of the disclosed concepts. Referring to FIG. 3, a gaming machine 310 includes game-logic circuitry 340 (e.g., securely housed within a locked box inside a gaming cabinet). The game-logic circuitry 340 includes a central processing unit (CPU) 342 connected to a main memory 344 that comprises one or more memory devices. The CPU 342 includes any suitable processor(s), such as those made by Intel Corporation and Advanced Micro Devices, Inc. By way of example, the CPU 342 includes a plurality of microprocessors including a primary (e.g., master) processor, a secondary (e.g., worker, helper, etc.) processor, a parallel processor, etc. Game-logic circuitry 340, as used herein, comprises any combination of hardware, software, or firmware disposed in or outside of the gaming machine 310 that is configured to communicate with or control the transfer of data between the gaming machine 310 and a bus, another computer, processor, device, service, or network. The game-logic circuitry 340, and more specifically the CPU 342, comprises one or more controllers or processors and such one or more controllers or processors need not be disposed proximal to one another and may be located in different devices or in different locations. The game-logic circuitry 340, and more specifically main memory 344, comprises one or more memory devices which need not be disposed proximal to one another and may be located in different devices or in different locations. The game-logic circuitry 340 is operable to execute all of the various gaming methods and other processes disclosed herein. The main memory 344 includes a wagering-game unit 346. In one embodiment, the wagering-game unit 346 causes wagering games to be presented, such as video poker, video blackjack, video slots, video lottery, etc., in whole or part.

The game-logic circuitry 340 is also connected to an input/output (I/O) bus 348, which can include any suitable bus technologies, such as an AGTL+ frontside bus and a PCI backside bus. The I/O bus 348 is connected to various input devices 350, output devices 352, and input/output devices 354.

By way of example, the output devices 352 may include a primary presentation device, (e.g., primary display), a secondary presentation device, (e.g., a secondary display), and one or more audio speakers. The primary presentation device or the secondary presentation device may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices, the audio speakers, lighting assemblies, and/or other devices associated with presentation are collectively referred to as a “presentation assembly” of the gaming machine 310. The presentation assembly may include one presentation device (e.g., the primary presentation device), some of the presentation devices of the gaming machine 310, or all of the presentation devices of the gaming machine 310. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device and/or the secondary presentation device, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 310. The gaming machine 310 may include a touch screen(s) mounted over the primary or secondary presentation devices, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 354 include one or more value input/payment devices and value output/payout devices. In order to deposit cash or credits onto the gaming machine 310, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 310. Examples of value input devices include, but are not limited to, a coin acceptor, a bill/ticket acceptor (e.g., a bill validator), a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 310. The credits may be exchanged for cash at, for example, a cashier or redemption station. Examples of value output devices include, but are not limited to, a coin hopper for dispensing coins or physical gaming tokens (e.g., chips), a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 348 is also connected to a storage unit 356 and an external-system interface 358, which is connected to external system(s) 360 (e.g., wagering-game networks, communications networks, etc.).

The external system(s) 360 includes, in various aspects, a gaming network, other gaming machines or terminals, a gaming server, a remote controller, communications hardware, or a variety of other interfaced systems or components, in any combination. In yet other aspects, the external system(s) 360 comprises a player's portable electronic device (e.g., cellular phone, electronic wallet, etc.) and the external-system interface 358 is configured to facilitate wireless communication and data transfer between the portable electronic device and the gaming machine 310, such as by a near-field communication path operating via magnetic-field induction or a frequency-hopping spread spectrum RF signals (e.g., Bluetooth, etc.).

The gaming machine 310 optionally communicates with the external system(s) 360 such that the gaming machine 310 operates as a thin, thick, or intermediate client. The game-logic circuitry 340—whether located within (“thick client”), external to (“thin client”), or distributed both within and external to (“intermediate client”) the gaming machine 310—is utilized to provide a wagering game on the gaming machine 310. In general, the main memory 344 stores programming for a random number generator (RNG) and game-outcome logic. Furthermore, in some embodiments, the main memory stores at least some game content (e.g., art, sound, etc.) and/or dynamically generates game content that is approved or authorized for presentation (e.g., the game content has either (1) received regulatory approval from a gaming control board or commission and is verified by a trusted authentication program in the main memory 344 prior to game execution or (2) is dynamically generated via an artificial intelligence model, such as a machine learning model that is trained to generate content that is compliant with regulatory, or other, requirements). In one example, an authentication program generates a live authentication code (e.g., digital signature or hash) from the memory contents and compares it to a trusted code stored in the main memory 344. If the codes match, authentication is deemed a success, and the game is permitted to execute. If, however, the codes do not match, authentication is deemed a failure that must be corrected prior to game execution. Without this predictable and repeatable authentication, the gaming machine 310, external system(s) 360, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 342 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 342 when executing the game-outcome logic to determine a resultant outcome for that instance of the wagering game. The resultant outcome is then presented to a player of the gaming machine 310 by accessing associated game assets, required for the resultant outcome, from the main memory 344. The CPU 342 causes the game assets to be presented to the player as outputs from the gaming machine 310 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 310 may be used to play centrally determined games. Centrally determined games are a type of game whose outcomes are determined by a central server and delivered to player terminals (e.g., to be displayed in an entertaining fashion). It includes, but is not limited to, Class 2 games, electronic pull-tab games, electronic scratch ticket games, historical horse racing, bingo games, etc. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 310 may include additional peripheral devices or more than one of each component shown in FIG. 3. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

FIG. 4 is a block diagram of a computer system 400 according to one or more embodiments. The computer system 400 includes at least one processor 442 coupled to a chipset 444, as indicated in dashed lines. Also coupled to the chipset 444 are memory 446, a storage device 448, a keyboard 450, a graphics adapter 452, a pointing device 454, and a network adapter 456. A display 458 is coupled to the graphics adapter 452. In one embodiment, the functionality of the chipset 444 is provided by a memory controller hub 460 and an I/O controller hub 462. In another embodiment, memory 446 is coupled directly to the processor 442 instead of to the chipset 444.

The storage device 448 is any non-transitory computer-readable storage medium, such as a hard drive, a compact disc read-only memory (CD-ROM), a DVD, or a solid-state memory device (e.g., a flash drive). Memory 446 holds instructions and data used by processor 442. The pointing device 454 may be a mouse, a track pad, a track ball, or another type of pointing device, and it is used in combination with the keyboard 450 to input data into the computer system 400. The graphics adapter 452 displays images and other information on the display 458. The network adapter 456 couples the computer system 400 to a local or wide area network.

The computer system 400 can have different and/or other components than those shown in FIG. 4. In addition, the computer system 400 can lack certain illustrated components. In one embodiment, the computer system 400 acting as the gateway 120 (FIG. 1) may lack the keyboard 450, pointing device 454, graphics adapter 452, and/or display 458. Moreover, the storage device 448 can be local and/or remote from the computer system 400 (such as embodied within a storage area network (SAN)). Moreover, other input devices, such as, for example, touch screens may be included.

The network adapter 456 (may also be referred to herein as a communication device) may include one or more devices for communicating using one or more of the communication media and protocols discussed above with respect to FIG. 1 or FIG. 2.

In addition, some or all of the components of the general computer system 400 may be used as part of the processor and memory discussed above with respect to the systems or devices described herein.

In some embodiments, a gaming system may comprise several such computer systems 400. The gaming system may include load balancers, firewalls, and various other components for assisting the gaming system to provide services to a variety of user devices.

The computer system 400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on storage device 448, loaded into memory 446, and executed by processor 442.

FIG. 5 illustrates an example gaming table system according to one or more embodiments of the present disclosure. Referring to FIG. 5, gaming table 580 includes several player stations 581, 582, and 583 where player participants can be seated. Each player station 581, 582, and 583 includes one or more bet spots (e.g., printed bet spots 584) where a player can place chips for betting on a wagering game conducted at the gaming table 580. Chips can be dispensed to the player from a chip tray 585 positioned at a dealer station. The dealer station can be associated with (e.g., communicatively coupled) to employee mobile device 104. Other devices (e.g., a shuffler 586, a printer 590, a camera 531, a projector 532, a display 587, etc.) can be associated with (e.g., incorporated into, attached to, communicatively coupled with, etc.) the gaming table 580 to capture and/or convey activities, content, information, etc. A separate player interface device 501 is incorporated into the gaming table 580 at each individual player station 581, 582, and 583. Each player interface device 501 is configured to communicate with a user computing device (e.g., player mobile device 102), such as via near-field communication (NFC) and/or with any other objects and/or devices at the gaming table 580 that include electronic components. For example, player interface device 501 is equipped with an NFC sensor. A user computing device (e.g., player mobile device 102) runs a camera application by which a player can scan information, such as a code (e.g., QR code) presented via the player interface device 501 at a respective player station. The QR code can includes information related to gaming-table asset information (e.g., a gaming table ID for gaming table 580 and player station ID for player station 581) and may include other information (e.g., QR ID, casino ID, asset IP, etc.).

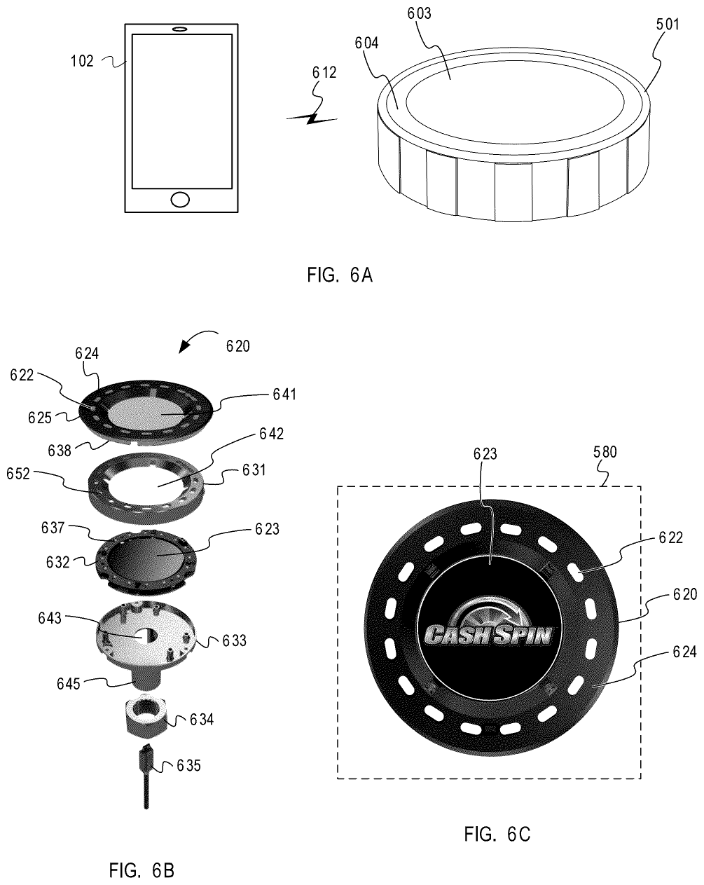

FIG. 6A illustrates an example of player interface device 501 (with similar functionality as player interface device 111 and configured to be embedded into a player station at gaming table 580). Referring to FIG. 6A, the player interface device 501 includes one or more displays, such as display 603 (e.g., an LED display) in which content or information is displayed (e.g. content related to gaming, information related to responsible gaming restrictions such as mandatory breaks in play, instructions, status, details, etc.). In one embodiment, the player interface device 501 has a round shape, such as a puck shape (e.g., a cylindrical shape with short side walls). The player interface device 501 is integrated with (e.g., embedded into, attached to, etc.) gaming table 580, such as via one or more holes drilled into the table surface into which the player interface device 501 is inserted. In one embodiment the top portion of the player interface device 501 includes the display 603. In one embodiment, the player interface device 501 includes multiple display portions, such as a primary display (e.g., display 603) and a secondary display (e.g., LED ring 604). The multiple displays can show different visual indicators (e.g., different background colors) so that multiple modes, menus, options, etc. can be displayed concurrently using the different visual indicators (e.g., a first color via LED ring 604 and a second color via display 603). The display 603 can also include a touch screen to receive user inputs.

The player interface device 501 can be positioned within a hole formed into the gaming table 580 such that the top of the player interface device 501 (the display 603) is flush with the table surface, thus appearing to the player as a sensor/display. In one embodiment, player interface device 501 can have a mechanism to raise or expose access to the player interface device 501 during configuration or during certain gaming states (e.g., for access by the dealer or other operator employees to change functions, menus, options, etc. of the player interface device 501, for access by player to press buttons related to gaming activities, responsible gaming practices, funds access, account access, etc., and so forth). In other examples, the player interface device 501 can be positioned such that the bottom of the player interface device 501 is flush with the table surface, thus exposing the side walls of the player interface device 501 to the participants during play (e.g., for use by participants to interface with the player interface device 501 during betting, during game play, during breaks, etc.). In one embodiment, the player interface device 501 can be situated inside the cylinder or they can be part of the player interface device 501 situated below the table surface.

The player interface device 501 can enclose components (e.g., sensors, processors, memory, wireless communications devices, etc.), such as an NFC communication device. In one embodiment, the NFC communication device enables an automatic wireless login to a player account via interaction (e.g., communication 612) with an NFC-enabled mobile device (e.g., without requiring the user to enter information manually into the display 603). The NFC device can communicate (e.g., during login as well as during a gaming session) with a mobile application (e.g., a web browser application, or other such mobile application, configured to load a Universal Resource Locator (URL) address, a mobile application provided by a gaming provider, a mobile application associated with gaming platform system 140 or gaming platform system 240, a mobile application associated with responsible gaming system 207, a mobile application associated with player tracking system 135 or player tracking system 209), such as to transfer/receive information about gaming events that occur during the gaming session. The NFC functionality of the player interface device 501 can communicate with other NFC enable devices (e.g., a smart watch, with employee mobile device 104, etc.)

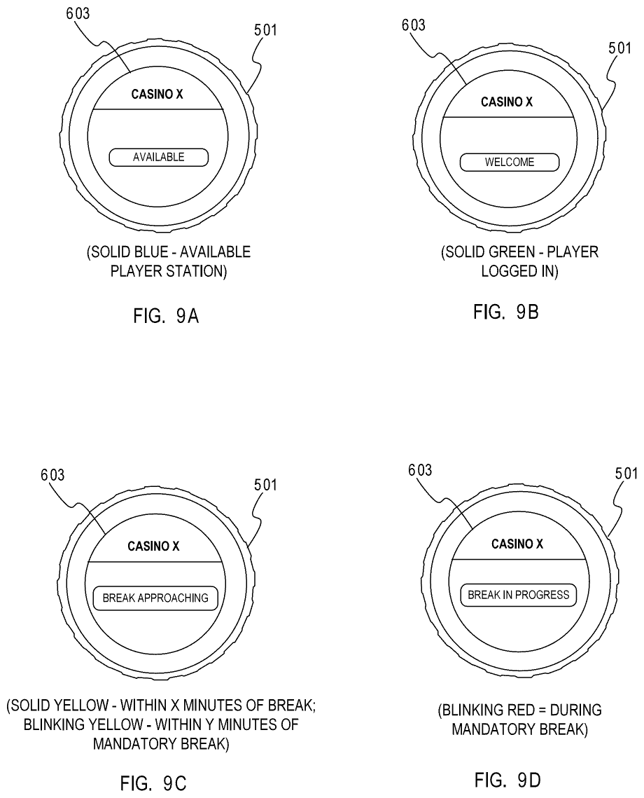

The player interface device 501 can be used for various purposes. Some examples include, but are not limited to, one or more of the following: identifying and communicating with electronic components or elements of a gaming device (e.g., gaming table devices such as cameras, projectors, speakers, dealer station, chip tray, shuffler, shoe, electronic gaming props, etc.); enabling a mandatory account-based connection (e.g., login) to a player account; monitoring event activities that occur via a gaming device (e.g., the gaming table 580) when logged into the player account; permitting access to a digital wallet associated with a player account; tracking events at the gaming table 580; purchasing and/or tracking usage and/or betting of chips at gaming table 580; generating printed gaming vouchers; receiving and/or redeeming loyalty rewards (e.g., points, gifts, bonuses, loyalty buckets, etc.); presenting loyalty balances; providing real-time promotions or marketing; enabling specific progressives or other secondary games at the gaming table 580; automatically generating ratings; initiating markers; performing combined promotions between land-based casinos and online gaming venues; and so forth. In one embodiment, the player interface device 501 (e.g., via the display 603) can change in appearance to indicate progress or timing of occurrence of a specific function over time (e.g., change color over time to indicate login status, to indicate stages of betting process, to indicate game play features, etc.). FIG. 9A, FIG. 9B, FIG. 9C and FIG. 9D (described in detail further below) illustrate an example of player interface device 501 at various example stages of notification of status associated with gaming states, such as availability of a gaming device, a timing associated with a mandatory break period, etc.

The player interface device 501 can include functions to move, rotate, orient, flip, turn, shake, etc. In some embodiments, the functions can make additional space available on the player interface device 501 for display, interaction, etc. For example, one side of the player interface device 501 can present content and/or provide functionality related to pre-game-play states (e.g., for login, for betting, etc.), whereas another side of the player interface device 501 can present content and/or provide functionality related to game-play states. For example, each side of the player interface device 501 can include a display, sensors, etc. present and/or detect information (e.g., being configured different depending on the state of the gaming process and/or game state required to be presented on a given side). In some embodiments, the player interface device 501 can be passed around to different participants at the gaming table (e.g., passed from one player station to the next), such as a dealer-managed player interface device that can be used in the case of group games or other activities. In some embodiments, the player interface device 501 can include a rotatable portion, such as a knob or dial (e.g., constituting rotatable sidewalls connected to a rotatable frame) as well as buttons incorporated into the side of the rotatable walls. The rotatable portion can be spun to select different modes, menus, options, etc., and the rotatable walls can be spun to select different modes, menus, options, etc. and/or sub-modes, sub-menus, sub-options, etc. (or vice versa). The walls of the rotatable portion can be made of soft material, such as rubber, so that buttons can be hidden underneath the soft rubber and accessed by pressing the button through the rubber walls. The rotation and/or buttons can be used by an operator employee to configure the player interface device 501 for use during a game play session. In other embodiments, the rotation and/or buttons can be used by a dealer or player to set or reset certain options (e.g., to restart a time after a break in play).

FIG. 6B and FIG. 6C illustrate examples of another player interface device configured for use with a gaming table according to one or more embodiments of the present disclosure. For instance, FIG. 6B is an example of an exploded view of an assembly for player interface device 620. The player interface device 620, for example, includes an enclosure backing 633 having screws, snaps, clips, latches, or other attachment means for attaching to a circular cap 631. Within the enclosure backing 633 (and below the cap 631) is inserted a circuit board 632 configured to control one or more electronics, such as light emitting diodes (LEDs) 637, display 623, a touch-screen overlay, etc. In one embodiment, sensors or other devices (e.g., an NFC sensor/communication device) can be positioned beneath the display 523 and can be incorporated into the circuit board 632. A frame 624 is positioned over the cap 631 and is configured to attach firmly to, and cover, the cap 631 (e.g., via a circular plastic lip 638 that attaches (e.g., via pressure) against an outer wall of the cap 631). The cap 631 includes an opening 642 and the frame 624 has an opening 641, which openings 642 and 641 align to permit the display 623 to be viewed from above. The opening 641 can include a protective film or layer to protect the display 623. The frame 624 also includes small openings 622 (aligned with openings 652 in the cap 631), which are positioned over LEDs 637. The frame 624 also includes a beveled edge 625. The enclosure backing 633 includes a hollowed-out protrusion 645 (e.g., a hollowed-out bolt-like protrusion) which can be inserted (e.g., screwed) into a nut 634 to provide a fastening or coupling of the enclosure backing 633 from underneath gaming table 580. A control wire 635 can be threaded through the nut 634, the protrusion 645, and the opening 643 to connect (e.g., communicatively couple) to the circuit board 632 and/or the display 623 to provide and/or read electronic instructions or other information or communications with the circuit board 632 and/or display 623.

FIG. 6C illustrates an overhead view of player interface device 620 embedded into gaming table 580. The beveled edge 625 rests flush upon a felt covering of gaming table 580 when assembled into the gaming table 580 (e.g., when incorporated into a hole in the gaming table 580). The small openings 622 can display light from LEDs 637. In some embodiments, the small openings 622 include coverings that can diffuse the light from the LEDs 637.

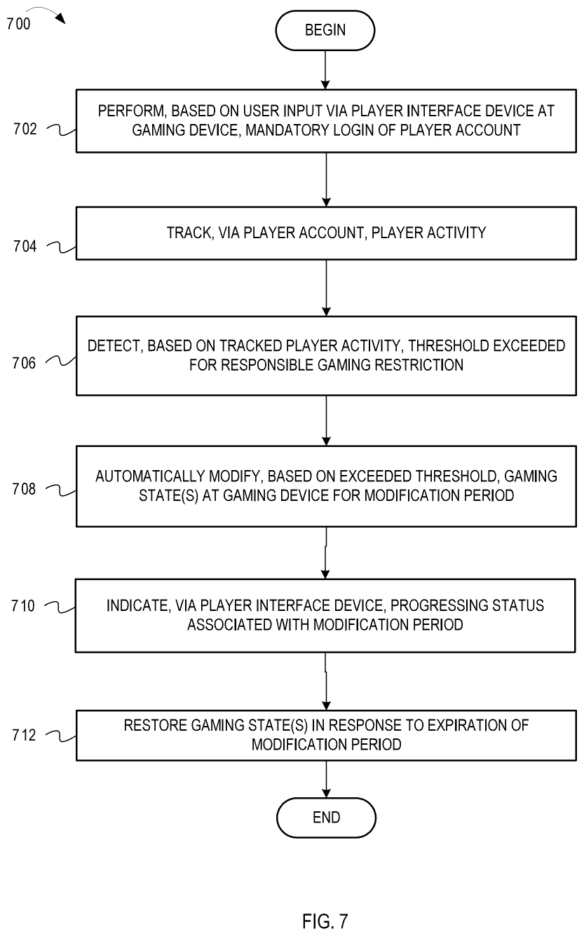

FIG. 7 illustrates an example of a method flow (“flow 700”) of an automated mandatory account-based gaming system according to one or more embodiments of the present disclosure. The description of FIG. 7 refers to a “processor” that performs operations associated with the flow 700. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, one or more devices of the network 100, such as any one of the devices in casino system 130, any devices connected via the casino network 132 (e.g., gateway 120, player tracking system 135, CMS 136, gaming device 110, player interface device 111, etc.), any device connected via the telecommunications network 160 (e.g., the gaming platform system 140, third-party system(s) 150, etc.), any device in casino system 230, or any device in gaming platform system 240. In one embodiment, the processor may be the central processing unit (CPU) 342 (see FIG. 3) or a processor in another device mentioned herein, such as the processor 442 associated with the computer 400, a table controller, a card-handling device, a camera controller, a game controller (e.g., game controller 112), a gaming server, etc. In one embodiment, the processor may be associated with gaming table 580 or any device associated with (e.g., at, connected to, etc.) gaming table 580. Furthermore, in some embodiments, the processor may be associated with player interface devices 501 or 620. In yet other embodiments, the processor is associated with a user computing device (e.g., mobile device 102 or 104). In some embodiments, the processor is associated with any element (e.g., device) of architecture 200.

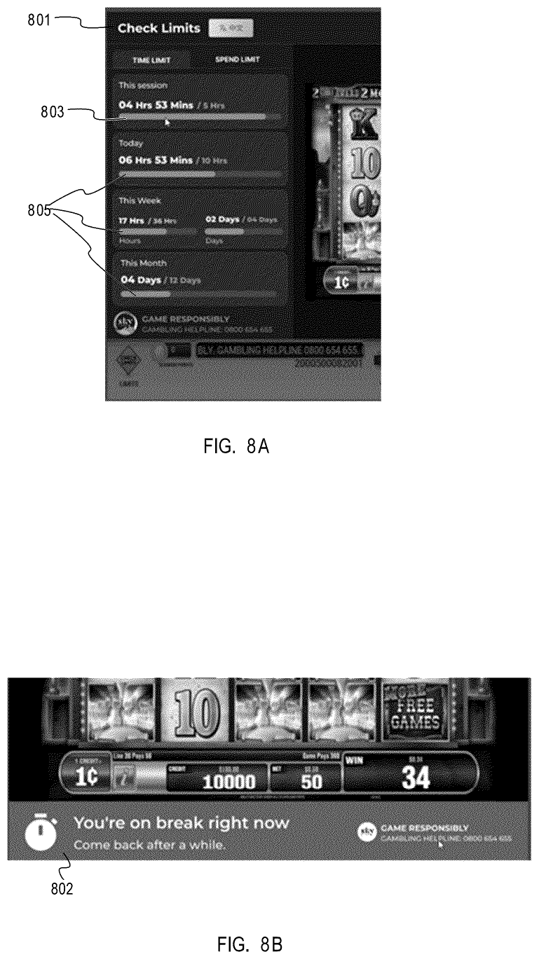

Occasionally, the flow 700 may refer to FIG. 1, FIG. 2, FIG. 3, FIG. 4, FIG. 5, FIG. 6A, FIG. 8A, FIG. 8B, and/or FIG. 9A-9D to describe various embodiments.

Referring to FIG. 7, the flow 700 begins at processing block 702, where a processor performs, based on user input via player interface device at a gaming device, a mandatory login of a player account. For example, the processor detects user input via a casino device associated with a gaming machine, such as a player interface device (and/or other device that can login a player to their player account (e.g., a casino loyalty-based account)). For example, as described in FIG. 6A, a player logs into the player interface device 501 via use of a user computing device (e.g., via NFC communication 612 by mobile device 102).

Referring again to FIG. 7, the flow 700 continues at processing block 704, where a processor tracks player activity during a gaming session at a gaming device. In one example, the player activity is tracked for each game play performed by a mandatorily logged in player account over a past period (e.g., over the last six months) as well as during a current gaming session. In some embodiments, the player activity is tracked by a slot event aggregator (SEA) or a table event aggregator (TEA).

The flow 700 continues at processing block 706, where a processor detects, based on the tracked player activity, that a threshold is exceeded for a responsible gaming restriction. In one example, a machine learning model determines (e.g., via segmentation/classification), based on the player activity over the past period an amount of gaming activity associated with the responsible gaming restriction. In some embodiments the responsible gaming restriction is set mandatorily, such as via a jurisdictional responsible gaming restriction (e.g., a required break period) that tracks a players amount of time (or other measure) spent gambling. In other embodiments, the processor detects one or more player activities (e.g., excessive activities), player behaviors (e.g., risk behaviors), etc. that trigger a restriction enforcement event. In one embodiment, the processor detects (e.g., via analysis by machine learning model) a level of the gaming activity. For instance, the processor detects (e.g., using AI tool 142) a player risk behavior (having a level of severity) associated with one or more responsible gaming restrictions. In some embodiments, as shown in FIG. 8A, a gaming machine presents options 801 to set, modify, and or check specific limits (e.g., time amounts, play amounts, etc.) in relation to the past tracked period, gaming restrictions, etc. For example, as shown in FIG. 8A, a first meter 803 indicates an amount of time that a player account is logged into and/or engaged in a current gaming session (e.g., at gaming machine 310). Meters 805 are also presented, which track an amount of time that the player account was logged into and/or engaged in past gaming sessions (e.g., over various past time periods, broken down into cumulative and/or specific individual amounts for given minutes, hours, days, months, specific dates, groupings thereof, etc.).

Referring again to FIG. 7, the flow 700 continues at processing block 708, where a processor automatically modifies, based on the exceeded threshold, one or more gaming states (“gaming state(s)”) at the gaming device. In one example, the modification involves implementing a mandatory break period, such as preventing gaming processes and/or functions of a gaming device during a specific period. In another example, the modification involves implementing an intervention strategy associated with a specific risk behavior. In some embodiments, the modification of gaming state(s) involves various restrictive gaming responses, such as, but are not limited to soft-type modifications of states (e.g., messages, alerts, suggestions, etc.) and hard-type modifications (e.g., an enforced break in play, an enforced suspension of operation of a gaming function, enforced intervention strategies, etc.). Some examples of certain intervention strategies are described in Table 1 and elsewhere in the present disclosure. In one example, the processor modifies the gaming state(s) based on, but not limited to, one or more of a degree of gaming session activity (e.g., time-based, event-based, spending-based, etc.), an amount of time initiating a game process, a degree of betting, a degree of game play actions, amounts of time spent completing game play (e.g., resolving wins and/or losses), etc. In one embodiment, the processor enforces a break in play in response to detection that a time-based threshold is exceeded.

The flow 700 continues at processing block 710, where a processor indicates, via a player interface device, a progressing status associated with the modification period. In one embodiment, indicating the progressing status involves modifying a range of indicators (e.g., a range of colors) on a portion of the player interface device to signify a range of change of status. In some embodiments, the change of status is associated with various processes, states, gaming functions, etc. over the gaming session, including before modification of the gaming state(s), during occurrence of modification, and after expiration of a modification period. In one embodiment, the processor selects, based on one of plurality of levels of risk behavior, an intervention strategy from a plurality of types of intervention strategies that correspond respectively to the plurality of levels of risk behavior. In one example, modifying the gaming state(s) involves disabling at least one gaming state function during a break time (e.g., disabling functionality at a gaming machine, notifying an operator to close disabling a player rating at gaming table during the break time, disabling functionality of a game controller of other gaming function accessible at a gaming table, etc.).

FIG. 9A-FIG. 9D illustrate a change of a level of status for a period associated with a player station at a gaming table. For instance, in FIG. 9A, the player interface device 501 (e.g., incorporated into a player station at a gaming table) shows a first status level prior to being logged into (e.g., a message is presented on display 603 indicating that the player station is available). The first status level can be associated with a first degree of indicator (e.g., a first color), such as presenting a blue colored background to indicate that the status indicates availably of the player station prior to being able to play at the gaming table (e.g., prior to and/or in association with processing block 702). The player interface device 501 is used to login to a player account at the player station. In FIG. 9B, the player interface device 501 shows, after the login, a second status level (e.g., a message is presented on display 603 indicating that the player station is in use). The second status level can be associated with a second degree of indicator (e.g., a second color), such as presenting a green colored background to indicate that the player station is in use (e.g., in response to processing block 702 and/or processing block 704). In FIG. 9C, the player interface device 501 shows, after a given amount of play time a third status level (e.g., a message is presented on display 603 indicating that the player station is reaching or close to initiating a break period (e.g., prior to processing block 706). The third status level can be associated with a third degree of indicator (e.g., a third color), such as presenting a solid yellow color when the break time is within a first number of minutes (e.g., within X number of minutes) before the break in play. As the timing gets even closer, the yellow color can begin to blink within a second number of minutes less than the first number of minutes (e.g., with Y number of minutes, where Y is less than X) to indicate that pending break in play is approaching. In FIG. 9D, the player interface device 501 shows, after the break time begins (e.g., in response to processing block 708), a fourth status level (e.g., a message is presented on display 603 indicating that the player station is in a break of play). The fourth status level can be associated with a fourth degree of indicator (e.g., a fourth color), such as presenting a red colored background to indicate that the player station is not accessible to the player account until the break period ends.

In other embodiments, the processor presents a notification such as that shown in FIG. 8B, where a gaming machine presents a notification 802, via a display of a player interface device, which shows a status of a break period. During the break period, all gaming functionalities can be disabled at a gaming machine except for a cash out function. Any attempt to login to the gaming machine, or any other gaming machine connected to a casino network during the break period would display the same notification 802. In one embodiment, the processor can notify player of the amount of time left on a break, such as via an actual timer and/or via login to a kiosk. In some embodiments, the processor can utilize an API to communicate with the kiosk or mobile app. In another embodiment, however, the processor can refrain from notifying the player of the timing (either in moments during game play leading up to a break or during breaks) so that the player does not know actual time values of impending or current breaks. For example, the processor can refrain from presenting a timer value so as not to reveal actual time values or indicators of upcoming break times to prevent a player from making larger or unreasonable bets in the moments prior to a beginning of a break. Further, the system can prevent presenting actual times during a break period so at to prevent a player from repeatedly checking the time remaining in a break. However, once the break begins, the color of the player interface device can change (e.g., to red) to signify the status of being on a break, and the color can change back to a different color (e.g., green) when the time for the break is over. In other embodiments, the processor can instead, or additionally, send notifications to player's mobile device if the break is over, or the processor can notify the operator via a single station at the casino (e.g., a Player's Club station) where the information can be obtained by verbal request.

The flow 700 continues at processing block 712, where a processor restores the modified gaming state(s) in response to expiration of the modification period. For example, the processor reenables disabled functions of a gaming machine, the processor sends a notification to the operator to reopen the player rating after expiration of the break time, etc. In one example, the processor notifies a dealer station to reinitiate play by re-enabling the gaming state functionality. The dealer station can further restore access to any given suspended or disabled function, such as restoring access to a player account and/or funds for gambling, restarting any play timers, modifying warnings/indicators presented on player interface device, etc.). In another example, the processor automatically restores a gaming state automatically in response to detection of a termination of a timer (e.g., a timer for a break-in-play period ends). The processor can, in response to the expiration of the timer, detect when the player account logs back into a gaming device and the processor can automatically restart the tracking of time related to the next possible break in play according to the responsible gaming restriction(s) associated with the jurisdiction, the operator, and/or the player account.

The following paragraphs detail various uses of a player interface device at a gaming device (e.g., gaming machine, gaming table, etc.) according to various embodiments of the present disclosure.

One example use of a player interface device is to enforce login to a customer account prior to enabling game play (mandatory account-based play). In one example, mandatory account-based play includes, but is not limited to, preventing either addition of funds to a gaming machine and/or access to chips or other funds at a gaming table, disabling game play functionality of a device (e.g., preventing use of a gaming machine, preventing access to a player station at gaming table, etc.). The functionality is not unlocked unless a valid account is logged into the gaming device (e.g., a valid card is placed into a gaming machine, a player logs into a player interface device via a mobile device, etc.). This ensures a valid and identified player is logged into the machine.

In one embodiment, the mandatory login via the player interface device ensures tracking of all gaming events that occur at the location in association with the player account. In one embodiment, real-time event aggregation/tracking occurs at a player station. In one embodiment, live table activity data service feed called a Table Event Aggregator (TEA) Service captures every event, in real-time/live as it occurs at the gaming table and sends the event to a player tracking system, to an artificial intelligence system, etc. The TEA service can detect and record chip transfers, bets, markers, redemptions, side bets, average bets, chip transfers to others, seat switches, comps or any other transactions or actions that are detectable at the table, which information can be used to automatically create ratings, track play, provide bonusing, etc. The TEA Service can further integrate with cameras, chip tray sensors, or other table sensors or devices used to track physical activities performed by the table participants. The TEA Service can integrate with a table management system (e.g., related to player ratings, chips requests, etc.) or a computer-vision or AI based tracking system to receive AI detected actions or activities. Player chip and betting activity is tracked (for all active player stations), and automatically generates ratings.

Another example use of a player interface device is to implement different jurisdictional responsible gaming restrictions. Different types of jurisdictions may implement responsible gaming in different ways. In one example, a player is limited in amount of time that can be played before a mandatory break is enforced. Hard and/or soft messaging can be used to warn players that are approaching mandatory break. The timing of the messages can be controlled as well as content. The message displays on a player interface device (e.g., as well as at dealer station). Soft messaging includes warnings. Hard messaging includes indicators of deactivated functionality, enforced break times, reduced or limited features, etc. For example, hard messaging may deactivate all functions of the gaming device except for a cash-out function (or equivalent cash out request). Another example of a hard message at a table includes a message to the dealer to refrain from rating the player (e.g., refrain from tracking an average bet of the player) while the player has a mandatory break status. The dealer station can be locked from making any changes to the player rating (or other status) during the break periods.

In some embodiments, the system can utilize jurisdictional required limits as well as a player self-defined limits (which can be stricter than that required for casino to enforce and/or could add additional restrictions). For example, a player can set more restrictive constraints, thresholds, tracked criteria, etc. than what is mandatory for a given jurisdiction (e.g., a player can choose to have a more restrictive level of tracking, the player may set lower thresholds for responsible gaming than is required for operator, etc.). The gaming system detects between the various setting(s) which is/are more restrictive and applies those limit(s) to the player. In one example, a jurisdiction may require only certain types of restrictions, whereas a player self-defined limit can include other restrictive criteria. For example, a casino may only require breaks based on an amount of play (e.g., for time periods of play), whereas a player can set additional limits, such as spending limits related to an amount spent (e.g., coin in, amount lost, etc.) during a given period, a calendar-based restriction (e.g., which days of week a player allows for play), etc.

Another example use of a player interface device is to enable a QR Code Login. For example, at a first stage, a player opens a mobile app on their mobile device and logs into player account using the mobile app (e.g., player logs into account (authenticates) via of mobile phone (or other mobile device, such as watch), causing the mobile app to validate the user's information and authenticate to the user account (e.g., to login to the player account or profile). At a next stage, the player launches a QR code connection via a mobile app. The mobile app validates the player information. At a next stage, a player scans a QR code shown on the player interface device. In one example, the QR code contains table asset information. By knowing what device the user is logged into, the gaming system can associate the player to a rating associated with a particular player station at a gaming table and/or for a particular gaming machine. At a next stage, a mobile server and a player tracking system (or table management system) shares a player identifier (player ID), an asset identifier (asset ID), etc. The player interface device and/or table management system initiates and/or opens a carded session. At a next stage a player and/or dealer ends a gaming session

Another example use of a player interface device is to enable an NFC login. In one example, a player can tap a personal device (e.g., mobile device 102) on an NFC supported player interface device, which either launches/links to the app on the mobile device or directs the mobile device to download the app (if not already installed, then player must either create an account and/or log into the account via the mobile app). The mobile app received, via the NFC communication, information about a gaming table or other associated gaming device (e.g., information about a player position at a gaming table system, information about table assets of a gaming table system, information about a gaming machine, etc.). Once the app opens on the mobile device, the user either logs in, or if already logged in, redirects the user to a confirmation screen from which the patron confirms the table information. In some embodiments, the NFC connection can communicate with a third-party wallet application on the mobile device (e.g., the Apple Wallet™ mobile app available from Apple Inc.), and can retrieve from the wallet application some information about the player and/or player account. For example, the player loyalty account is associated with the third-party wallet application (e.g., via a user-initiated configuration), and the player interface device can obtain information about the player loyalty account (e.g., player loyalty account identifier) from the interaction with the configured wallet application on the mobile device.

Another example use of a player interface device is to enable purchase/tracking usage of chips at a gaming table. For example, a player can launch a QR code detection app on the mobile device. Mobile app validates player information. The player scans a QR code shown on player interface device. The QR code contains table asset information (and/or player interface device details). At a gaming table, a player is positioned at a given player station. On the gaming table, a separate interactive sensor is positioned at each player position. For instance, player interface device presents unique QR code associated with player station at the specific gaming table (i.e., the player station has an associated player station ID used by a gaming platform system to track events, associated with the player account, at the player station). The player can scan using the camera of their mobile device.

In one embodiment, the player interface device includes a bet sensor, such as to detect placement of tokens (e.g., casino chips) over or onto the sensor (e.g., detection of environmental lighting differences, touch detection, weight detection, detection of some other property of a chip or stack, etc.). In one example, a mobile server and table management system shares player ID and asset ID. The player interface device and/or table management system initiates and/or opens a carded session. The player interface device displays status of purchases (e.g., of chips).

In some embodiments, the player interface device interacts with a computer vision or other type of chip or bet tracking system or feature of a gaming table (e.g., an automated machine learning system or other AI-based tracking system), such as to show notifications of tracking of bets that occur (e.g., the player interface device displays information from the bet tracking system about an amount of a detected chip stack placed into a bet spot on the table).

Another example use of a player interface device is to create and/or track a player rating at a gaming table. When a player logs in, the player can create/open a rating for the game.

Another example use of a player interface device is to present a progression of status of a gaming process using visual indicators (such as timers, color coded options, etc.) In some examples, the display can present a timer, color, or other indicator of timing, progress, state changes, etc. related to any process for gaming (e.g., purchasing, betting, playing, redeeming, etc.). The timer can be used for various purposes, such as, but not limited to a player station status (e.g., see FIG. 9A-9D).

Another example use of a player interface device is to automate and/or enforce responsible gaming restrictions. In some current jurisdictions, dealers have to use a separate table device to track mandatory breaks for customers. This represents a challenge for dealers and operators due to divided attention between game responsibilities, customers, and screens. This represents a risk of errors due to distractions, and a missed initiation of a mandatory break in play. Thus, in some embodiments, player interface device (in association with other table devices and/or sensors, such as the devices and/or sensors from a computer vision system) automatically tracks an amount of time of play or a degree of betting and notifies, based on the tracked play/betting, notifies of the mandatory breaks by indicating to the player when to take a break from playing, when the break occurs, and/or when the break is over. The player can self-select the time that they want for the break pattern (e.g., may be less than maximum amount allowed by casino, may be tier-based, etc.). For example, each player, based on their preference, can select from multiple tiers whose notifications (e.g., visual indicators) are associated with varying levels or degrees of betting and/or timing. Thus, each player at a table can be tracked according to different tiers or levels. The player interface device can further communicate to a dealer station (or associated dealer tablet) information about the number of players being tracked (e.g. their time in a certain playing zone close to the table, their amount or degree of betting, etc.), information associated with break schedules, information about options for interacting wirelessly with a player interface device (e.g., to update and/or change settings, features, options, indicators, etc. related to the mandatory breaks), and so forth.

Another example use of a player interface device is to incorporate usage of a machine learning model (e.g., a responsible gaming AI model). A responsible gaming AI model can anticipate problematic behavior by detecting early signs of at-risk behavior and proactively introducing personalized interventions. The approach creates a safer gaming environment and also meets regulatory requirements more effectively than traditional methods. The responsible gaming AI model (AI model) monitors events in real time (e.g., via a slot event aggregator (SEA) server and/or table event aggregator (TEA) server) to track various player activity and behavioral patterns, such as session length, bet size increases, deposit frequencies, etc. The AI model then calculates two key ratios: a time played ratio and a monetary ratio. These ratios compare a player's current session against their average behavior over a past range of time (six months). If the player's current activity exceeds a pre-defined threshold, then the AI model can detect the problem behavior (e.g., is the player advancing or performing gaming activity in stages of behavior, such as from a normal/casual player to an advanced player, to a problem gambler). In some embodiments, a gaming device implements an intervention strategy that is personalized for a particular risk behavior. The gaming device can notify a casino of the detected behaviors, thresholds, classifications or segmentations, etc., as they occur. The casino can initiate and/or assist in any automatically initiated responsible gaming events, intervention strategies, etc.

In one embodiment, a gaming device (e.g., via a player interface device) uses different colors or indicators to show a range of detected player behavior and/or to show whether behavior has exceeded a certain threshold (e.g., time-based threshold, use-based threshold, money-based threshold, etc.). If a player's detected level of behavior currently falls within a given part of the range of behaviors (e.g., a low end, such as normal play), then the player interface device can show a first color, such as green. If the prediction is closer to a different part of the range (e.g., a high end, such as a potentially problem gambler), then the player interface device can indicate a second color, such as red, to indicate that a threshold is exceeded. Thus, the player interface device can be utilized to illustrate thresholds associated with user behaviors. In response, different intervention strategies (e.g., a notification, an educational presentation, an enforced break in play, an offer to assist in reduction of play rate, etc.) can be implemented that match the degree or level of the player in relationship to the tracked behavior and/or detected player segmentation. For example, a low-range level may require low-limited intervention strategy. For instance, a player interface device provides brief notification, such as a message sent to a player mobile device. A color of the player interface device remains a default color. This may be referred to as a soft intervention as it does not restrict actions, only makes a patron aware of risk behaviors. A medium-range level may require a medium-level intervention strategy. For example, a player interface device changes in color from first color to a second color, with initiation of time tracking for play. A high-range level may require a high-level intervention strategy. For example, a player interface device changes in color to red, an alert is sent to casino staff to take appropriate intervention measures (conversation, provide responsible gaming resources, set limits on player's account, etc.), an enforced break in initiated, an offer is provided intended to slow or reduce play, a promotion is offered to change game, a decrease in an amount of a timer of play occurs, etc. An enforced intervention or other such restrictive intervention action may be referred to as a hard intervention,

By monitoring risk behaviors against predefined thresholds, players can be segmented into different categories based on their risk level. Each segment can then receive tailored interventions that promote responsible gaming without being overly intrusive, ensuring that players are made aware of risky behavior in a supportive manner. For example, the AI model tracks player activities and segments the player in various ways (which are each a basis for generating a different type of notification at the player interface device). For example, the appearance and/or function of the player interface device can vary (e.g., have different indicators or effects, provide different functionalities, enact time-based or other restrictions, etc.) according to the different labels associated with the segmentation of the player and/or based on detection of specific risk behaviors about a player.

The following paragraphs (and TABLE 1) illustrate various examples of detectable risk behaviors, sample thresholds, player segmentations, and/or associated intervention strategies. In one example, the risk behavior detected is a sudden spike in time spent playing, for instance, a player who typically visits the casino for two hours on an average in the last six months suddenly spends six hours on the floor (i.e., a 300% increase). As an example intervention strategy, the AI model triggers a red light, prompting staff to monitor the player's activity more closely (e.g., a soft intervention).

In another example, the risk behavior detected is a significant increase in spending, such as a detection of player who typically wagers modest amounts has suddenly begun placing larger bets compared to their average wager amounts over the last six months. As an example intervention strategy, the AI model triggers a red light and also sends an alert to the responsible gaming team. The player may be contacted to discuss setting limits or to offer assistance.

In another example, the risk behavior detected is a combined extended play with high wagering, such as a detection that a player not only stays longer than usual but also increases their betting amounts significantly. As an example intervention strategy, the AI model triggers the highest level of alert (red light). Further, the AI model automatically implements a hard intervention action, such as automatic implementation (or sending a recommendation to staff to implement) to restrict the player's betting limits or offering counseling services. TABLE 1 illustrates other examples of various behavior risks, thresholds, player segmentation labels, and intervention strategies.

TABLE 1

| | | Player | Intervention |
|---|---|---|---|
| Behavior Risk | Sample Thresholds | Segmentation Label | Strategy |
| Excessive Session | More than 4 | Marathon Gamer | Send a message |
| Length | consecutive hours | | recommending a |
| | without a break | | break |
| Multiple Sessions in | More than 4 sessions | Intense Gamer | Suggest taking time |
| Short Time | within 12 hours | | off between sessions |
| High Frequency of | More than 3 deposits | Deposit Spike | Notify player and |
| Deposits | in 24 hours | | recommend setting |
| | | | deposit limits |
| Significant Increase | Bet size increases by | Risk Taker | Warn about sudden |
| in Bet Size | 50% over short | | increase in risk- |
| | period | | taking behavior |
| Chasing Losses | Doubling bets after | Loss Chaser | Alert about chasing |
| | losses | | losses, advise |
| | | | responsible betting |
| Irregular Sleep | Playing between 12 | Night Owl | Recommend getting |
| Patterns | AM and 5 AM | | rest and avoiding |
| | consecutively | | late-night play |
| Escalating Financial | Deposits increasing | Financial Risk | Suggest setting |
| Commitments | by 75% over previous | | financial limits |
| | week | | |
| Rapid Session Re- | Re-entering session | Fast Responder | Encourage longer |
| entry | within 10 minutes of | | breaks between |
| | exit | | sessions |
| High Volume of | Multiple withdrawals | Inconsistent Cash | Advise review of |
| Cashouts and | followed by | Handler | spending and |
| Redeposits | redeposits | | withdrawal habits |
| Ignoring Responsible | Ignoring more than 3 | Warning Ignorer | Escalate with |
| Gaming Warnings | warnings in a week | | personalized message |
| | | | encouraging |
| | | | responsible play |
| Increasing | Switching from low | High-Risk Player | Warn about risky |
| Aggression in Play | to high-stake games | | behavior and suggest |
| | abruptly | | moderation |
| Frequent Switching | Playing more than 5 | Game Hopper | Suggest focusing on a |
| Between Games | different games in a | | single game, evaluate |
| | session | | behavior |
| Bonus/Promotion | Only playing during | Bonus Hunter | Educate about risks |
| Dependency | promotions | | associated with |
| | | | bonus-chasing |
| Abnormal | Large withdrawals | Withdrawal Anomaly | Advise reviewing |
| Withdrawal Requests | after losses, | | financial habits and |
| | redeposits | | limits |
| Emotional Betting | Increasing bets by | Emotional Bettor | Recommend stepping |
| Patterns (Tilt | 50% after a | | away to avoid |
| Behavior) | significant loss | | emotional betting |
| Frequent Max Betting | Max betting more | Max Bettor | Warn about high- |
| | than 5 times per | | stakes betting, |
| | session | | suggest betting limits |
| Refusal to Self- | Declining self- | Self-Exclusion | Strongly suggest |
| Exclude | exclusion after risky | Resistor | cooling-off or |
| | behavior | | temporary self- |
| | | | exclusion |
| Exceeding Self-Set | Exceeding personal | Limit Breaker | Reinforce sticking to |
| Limits | limits on deposits or | | self-set limits, |
| | losses | | recommend |
| | | | adjustment |
| Large Financial | Large swings in | Financial | Advise setting loss |
| Fluctuations | account balance | Fluctuator | limits, recommend a |
| | | | break |
| Using External Credit | Deposits using credit | Credit Risk | Alert player to risks |
| | or loans | | of using borrowed |
| | | | money |
| Increased Playtime | Continuing gambling | Over-Confident | Suggest withdrawing |
| After Big Wins | after significant wins | Player | winnings and taking a |
| | | | break |
| Multiple Failed | More than 3 failed | Deposit Struggler | Advise checking |
| Deposit Attempts | deposit attempts in 24 | | financial situation, |
| | hours | | suggest responsible |
| | | | limits |

While Table 1 illustrates some example intervention strategies, it is not an exclusive list. For example, as indicated herein intervention strategies can have various levels, such as ranges between soft interventions (e.g., recommendations or suggestions sent via messages via a player interface device) to hard interventions (e.g., enforced breaks in play, automatic disabling or suspension of gaming functions of a gaming device, prevention of opening or editing a player rating via a table management application, and so forth). For example, any of the sample thresholds described in Table 1 may be considered one level of a threshold. Other levels may exceed those listed and may increase the amount of activity indicated as an intervention strategy and/or may add additional actions to be performed for the intervention strategy, such as hard intervention strategies.

In some embodiments, the AI model can perform trend analysis. The AI model can track trends, such as a gradual shift from a certain level of gaming behavior to other. For example, the AI can determine, via trend analysis, that a first level of behavior (e.g., a casual play behavior or a non-at-risk behavior) has shifted to a second level behavior (e.g., an at-risk behavior) or that a second level of behavior has shifted to a third level behavior (e.g., a problem gambler). The AI model automatically intervenes before the player progresses to a next level. The following are examples of trends that the AI model can track: increasing session length over time with fewer breaks; frequent deposits or larger deposit amounts in a short period; higher bet sizes or chasing losses more often; frequent late-night play, particularly over consecutive nights; ignoring responsible gaming prompts and failing to set limits; large fluctuations in account balance, with rapid withdrawals and redeposits, etc. The AI model can combine detection of the trend into a multi-feature tracking system. For example, the AI model can establish baseline metrics. For example, the AI model establishes baseline metrics for each player based on their 120 days or 180 days average such as their typical average session length, bet size, deposit frequency, and playtime. In another example, the AI model can detect behavioral shifts. For example, the AI model monitors for shifts from baseline metrics. For example, a 20% increase in session length over a month or a 50% rise in average bet size could trigger an alert.

The AI Model can further perform pattern aggregation. For example, the AI model can aggregate multiple factors over time, such as increasing session length, larger deposits, and ignored responsible gaming messages.

The AI model can further perform risk scoring. For example, the AI model assigns a risk score to each player based on their aggregated behaviors. A player whose risk score exceeds a certain threshold could move from the casual category into the at-risk category, and further escalation can signal a move into the problem gambler category.

The AI model can further perform escalating interventions. For example, the AI model tailors interventions based on the player's risk score. For instance, a casual risk score merits only light reminders about breaks and limits. An at-risk score merits assertive messages suggesting deposit limits and longer breaks. A problem gambler score merits strong interventions such as self-exclusion recommendations or mandatory cooling-off periods.

Another example use of a player interface device is to present game play functionality or other game states. For example, the player interface device can present timing of a specific game state, timing for placing bets, timing for performing specific game actions (e.g., throwing dice, playing a hand of cards, etc.), timing for a given game feature to occur (e.g., timing for a bonus game duration or feature, timing for a picking action, timing for a modifier to be in effect, etc.), and so forth.

Another example use of a player interface device is to present promotions or marketing offers. Promotions and/or marketing offers (e.g., bonusing, promotions, free plays, comps, markers, etc.) can be based on an amount of time a player has played, thus a timer or range of visual indicators can notify the timing related to the time until the marketing offer will be available or awarded. For example, the player interface device integrates with a bonusing system to give incentives to play more, bet more, bet higher, perform side bets, bet two positions, etc. For example, the player interface device can enable access to a gifting promotion (e.g., to display that a Player Boutique item was earned, for example as described in U.S. Pat. No. 12,014,599, issued Jun. 18, 2024, the entirety of which is incorporated by reference herein). In another example, the player interface device performs combined promotions between land-based casinos and online gaming venues where a player has to play different types of games or play on different types of gaming devices (e.g., a slot machine, mobile, iGaming, a gaming table, etc.).

In another example, a player interface device can present states related to a table game (e.g., login states, betting states, game-play states, communication states, etc.) In one example, the player interface device determine whether to display information based on the current game state, an amount of space available on the player interface device for presentation of content, a priority of the gaming process, and/or based on whether the gaming process would delay or interfere with the flow of the game (e.g., an override feature available at dealer station and/or game logic to make a decision to limit non-information presented on the player interface device). If the content is high priority, the player interface device can present a minimal version of the content on the player interface device such as minimally important information to convey, including, but not limited to a message to look at any other device (e.g. via a mobile device, via signage, via a display associated with presentation of a table management system, etc.) that can present a more detailed version of the content, which includes additional details beyond the minimal version of the content and/or which clarifies or elaborates on the minimal version of the content.

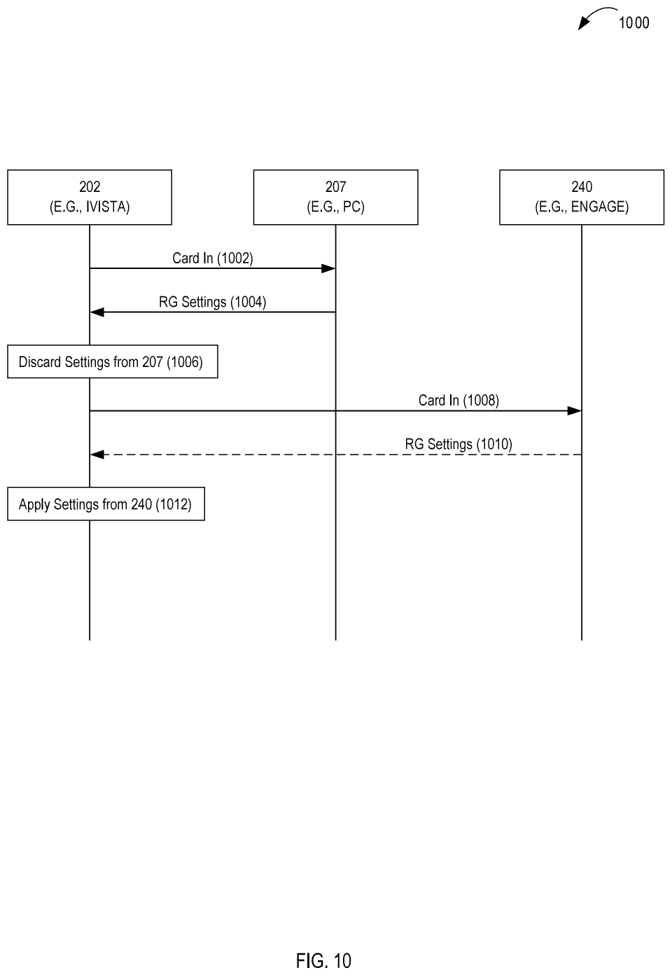

FIG. 10 through FIG. 27 illustrate method flows according to one or more embodiments of the present disclosure. Regarding the description of the flows in FIG. 10 through FIG. 27, in at least some embodiments, the gaming platform system 240 operates via use of the Engage™ product (“Engage”), the responsible gaming system 207 operates via use of the Pre-Commitment™ product (PC), the web-based interface application 202 operates via use of the iVISTA™ product (“iVISTA”), the table management system 204 operates via use of the TableView™ product (“TABLEVIEW”), and the third-party management application 241 operates via use of the Envoy™ product (“Envoy”). In some embodiments, on card into (1008) a gaming machine (also referred to herein as an electronic gaming machine (EGM)) (e.g., see flow 1000 in FIG. 10) responsible gaming parameters (“RG Settings”) are sent (1010) by gaming platform system 240 in association with responsible gaming system 207. A first set of responsible gaming parameters (“RG Settings” via 1004) may be referred to as basic responsible gaming functionalities (e.g., wager limit, loss limit, time limit). In one example, the basic responsible gaming functionalities depend on whether the player is enrolled or not as a user. If enrolled, the wager limit can be set to how much can be played maximum in a day, week, month, year, etc. If enrolled, the loss limit can be set to how much can be lost maximum in a day, week, month, year, etc. If enrolled the time limit can be set to how much time can be played in a day, week, month, year, etc. For the basic responsible gaming functions, a list of percentages is presented to the player. Further, for basic responsible gaming functionalities, the game can be disabled if a restriction threshold or limit is reached. Furthermore, the web-based interface application 202 periodically sends updates to gaming platform system 240

A second set of responsible gaming parameters (“RG Setting” at 1010 responsive to 1006 and 1008) may be referred to as extended responsible gaming functionalities (e.g., break in play, no play period). A break in play involves one or more settings or functions (e.g., “Apply Settings from 240” at 1012) regarding setting times or other thresholds for a maximum continuous play period, a break period, and a determination as to whether the player is already in a break period. A no play period involves a restriction that the player cannot play currently.

If a player is enrolled for basic responsible gaming functionalities, the web-based interface application 202 tracks (1002) all coin ins and coin outs to calculate the wager done, amount lost, time spent and display notifications when certain percentages are met (e.g., approaching limit) and once the limit is reached, displays a notification and disables the gaming machine based on the configurations received from gaming platform system 240.

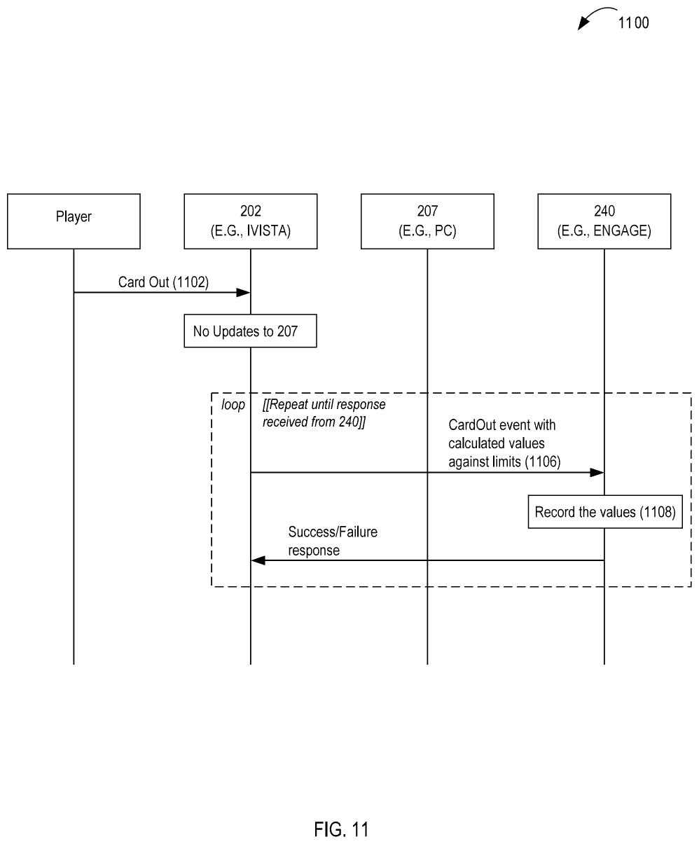

In some embodiments, on card out (1102) to a gaming machine (e.g., see flow 1100 in FIG. 11) the web-based interface application 202 would make an API call (1106) to gaming platform system 240 to record (1108) all the latest game plays (e.g., amount wagered, amount lost, time spent) so that gaming platform system 240 can update values for the player.

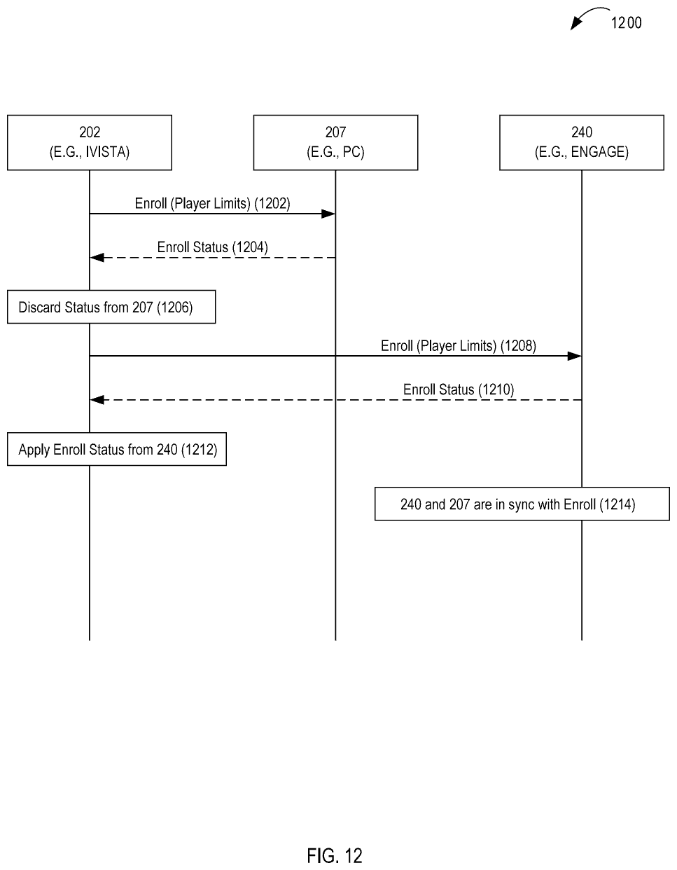

In some embodiments, on card in at a gaming machine (e.g., see flow 1200 in FIG. 12), if the player account is not enrolled with basic responsible gaming functionalities, the web-based interface application 202 prompts the player to enroll for the basic responsible gaming functionalities and send enrollment details (1202) to responsible gaming system 207 (1202) and to gaming platform system 240 (1208) so that both systems are in sync (1214). Both responsible gaming system 207 and gaming platform system 240 can send a response (1204, 1210) to the enroll event from web-based interface application 202. In one embodiment, the web-based interface application 202 only uses the provided response of gaming platform system 240 (1212) and discards the response from responsible gaming system 207 (1206).

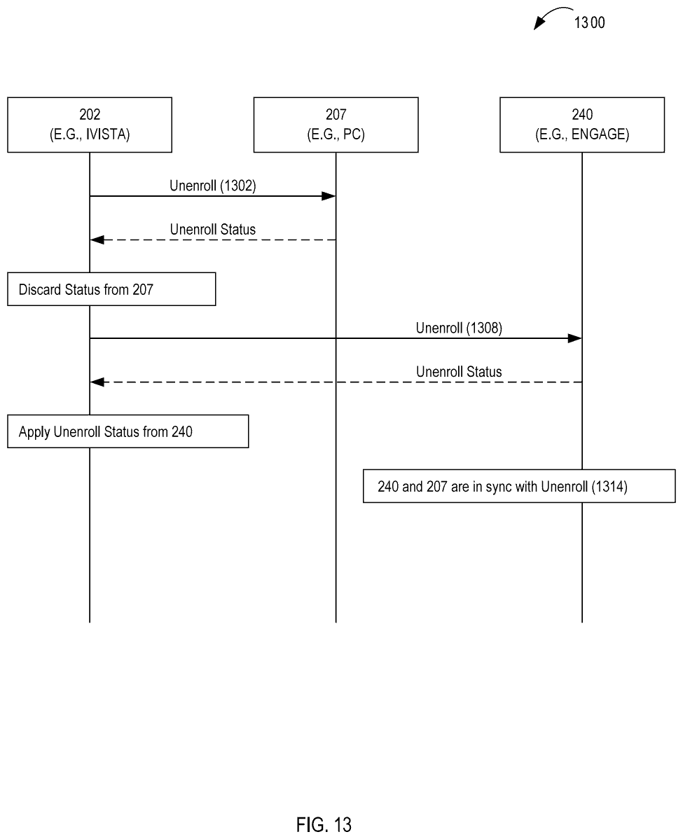

In some embodiments, a player can unenroll via a gaming machine (e.g., see flow 1300 in FIG. 13) via the web-based interface application 202, which sends unenroll details to responsible gaming system 207 (1302) and to gaming platform system 240 (1308) so that both systems are in sync (1314).

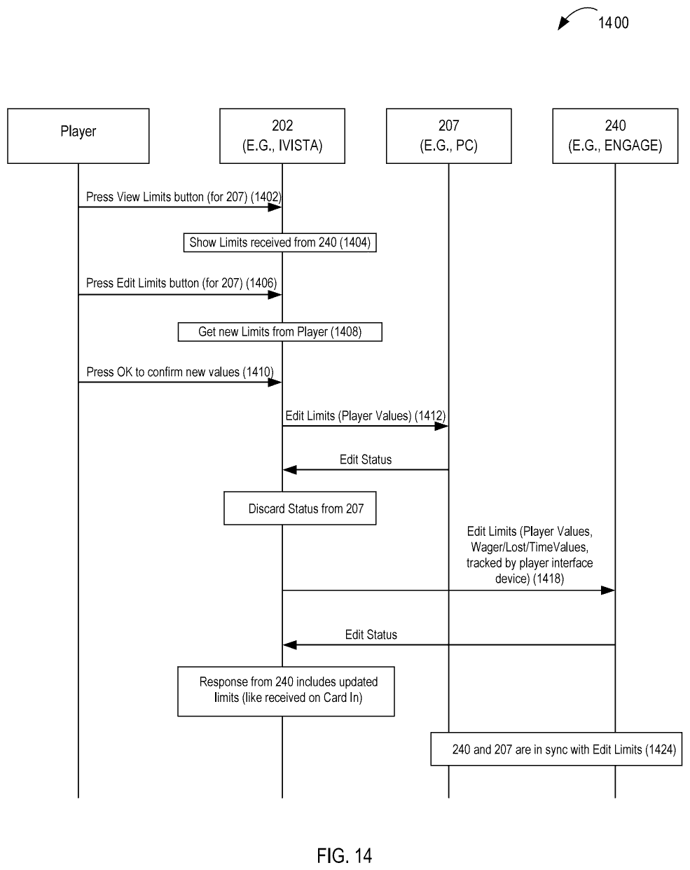

In some embodiments, a player can edit their responsible gaming restrictions at a gaming machine (e.g., see flow 1400 of FIG. 14). For example, the gaming machine presents, via web-based interface application 202, a user interface with a “View Limits” button (1402). Upon click of the “View Limits” button on the web-based interface application 202 user interface, the web-based interface application 202 displays current responsible gaming restrictions as received from gaming platform system 240 on card in (1404). The user interface on web-based interface application 202 can further present an “Edit Limits” button (1406). Upon click of the “Edit Limits” button, the web-based interface application 202 gets the modified values from the player (1408) and sends the details to responsible gaming system 207 (1410, 1412) and to gaming platform system 240 (1418) so that both systems are in sync (1424).

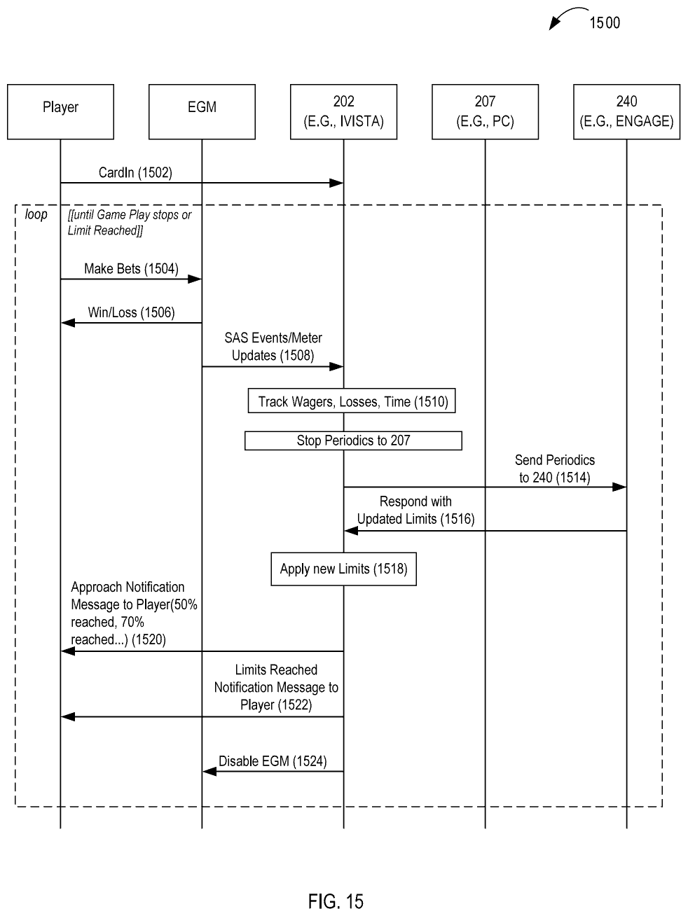

In some embodiments, the gaming platform system 240 can determine when a player is reaching one or more responsible gaming limits at a gaming machine (referred to as “EGM”) (e.g., see flow 1500 in FIG. 15). During a gaming session, each game played (1504, 1506), and the time taken for the session (1508) will continuously be tracked (1510) by web-based interface application 202. The tracked values will be compared against the limits and approaching notifications (1520) and limit reached notifications (1522) will be shown by web-based interface application 202 based on the configurations received at card in. Periodic updates are to be sent to gaming platform system 240 (1514) and gaming platform system 240 will apply new values and respond back with any updated limits (1516) (based on events at a gaming table(s) 203 or at gaming machines 201 for that player) for web-based interface application 202 to apply (1518).

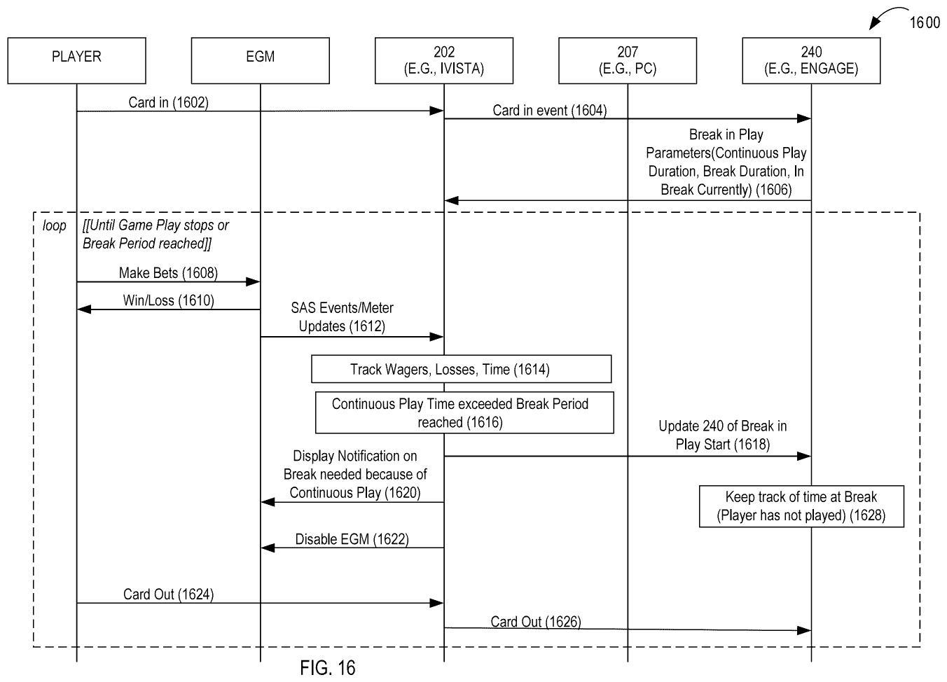

In some embodiments, the gaming platform system 240 can enforce a break in play at a gaming machine (e.g., see flow 1600 in FIG. 16). For example, the web-based interface application 202 can, in response to card in events (1602, 1604), use the “Max Continuous Play Period” from gaming platform system 240 (1606) to determine at what point (1608, 1610, 1612, 1614) to enforce a break period (1616, 1618) for a duration specified by gaming platform system 240. During the break period (1628), card inserts would result in a notification shown and the gaming machine would be disabled (1622) (based on configuration from gaming platform system 240) until break period is reached or game play stops (1624, 1626).

Regarding the use of the gaming platform system 240 for gaming tables, table management system 204 integrates with player tracking system 209 for all the existing transactions. In some embodiments, the table management system 204 integrates with gaming platform system 240 via the third-party management application 241 to fetch only player continuous play time details and corresponding configurations. For zone scenarios, the zone app (e.g., zone app 242) will invoke an API of the table management system 204 to intimate whenever a player enters or exits a zone. The sync service 244 fetches all the configured gaming tables(s) 203 on the floor by directly invoking the database 205 of the table management system 204.

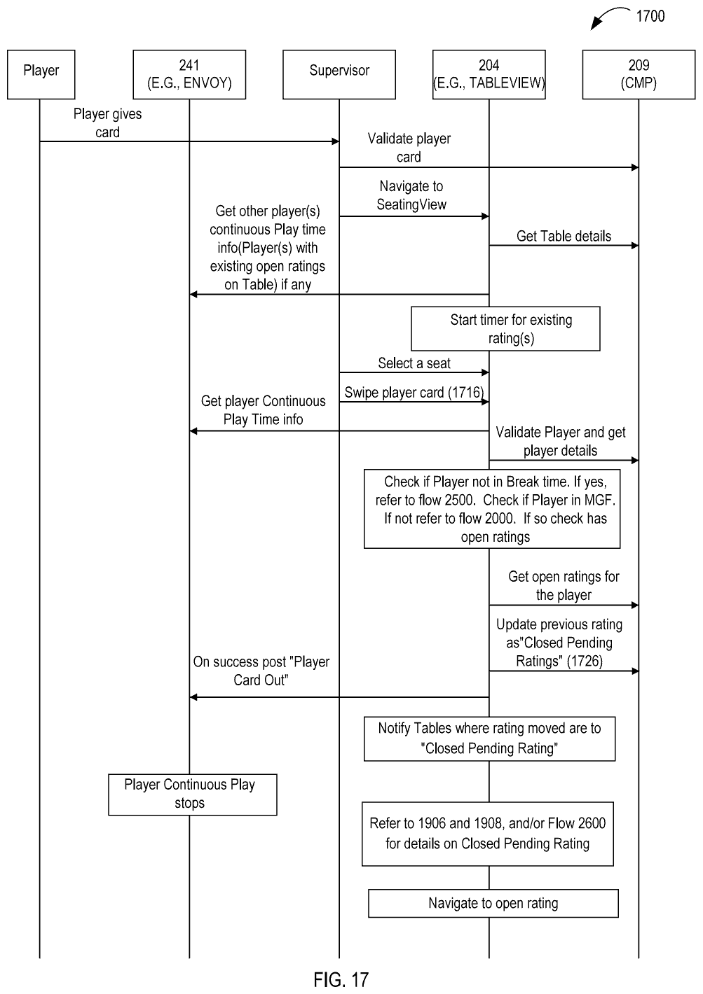

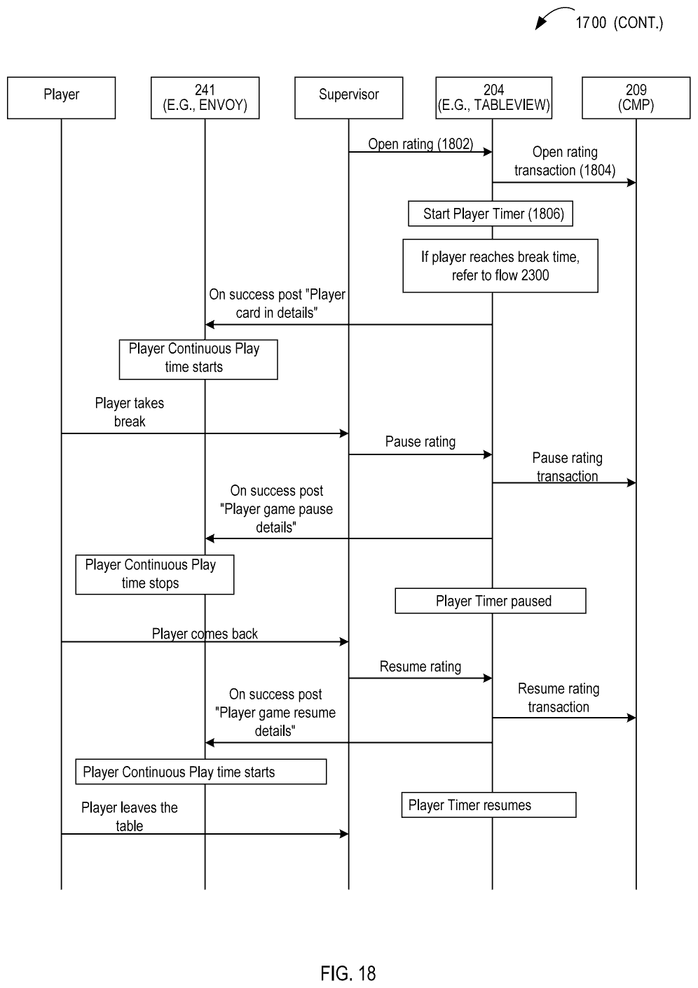

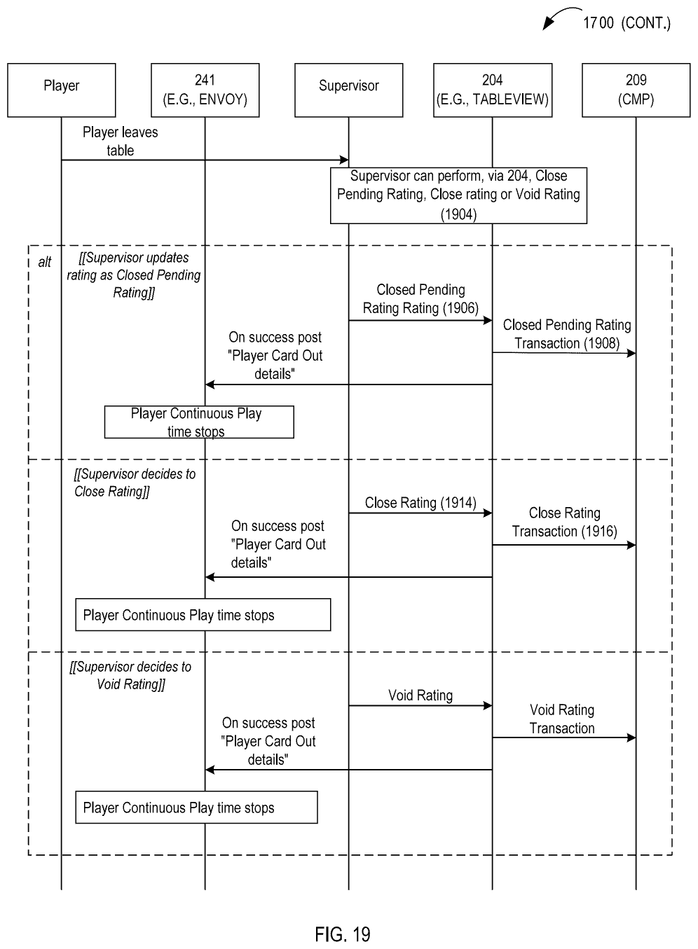

In some embodiments, the gaming platform system 240 performs a player rating transaction in a mass gaming floor (MGF) configuration (e.g., see flow 1700 in FIG. 17, FIG. 18, and FIG. 19). Mass Gaming Floor allows participants with limited restrictions. It is a section of the casino floor where the general public can play. For a player rating transaction in MGF, a player break time tracking starts when a player rating is opened in an MGF table (1802, 1804, 1806). The break time tracking stops when the player rating is closed (1914, 1916). Furthermore, multiple player ratings are not allowed in the MGF table. When a new rating is opened (1716) without closing the previous rating, the previous rating is updated as “Closed pending ratings” (1726). Supervisors can later review and close or void these ratings (1904).

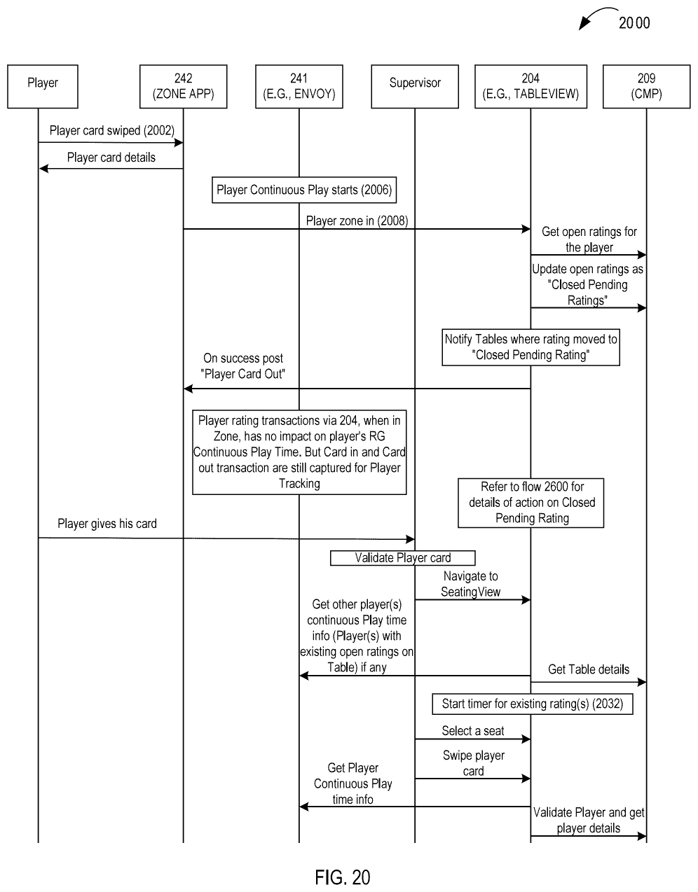

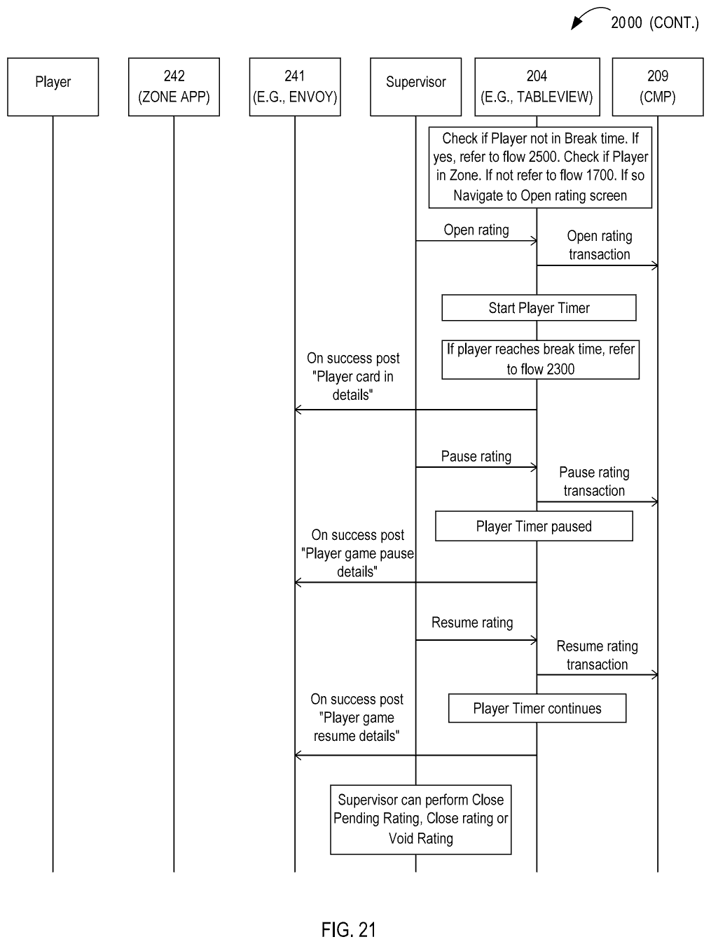

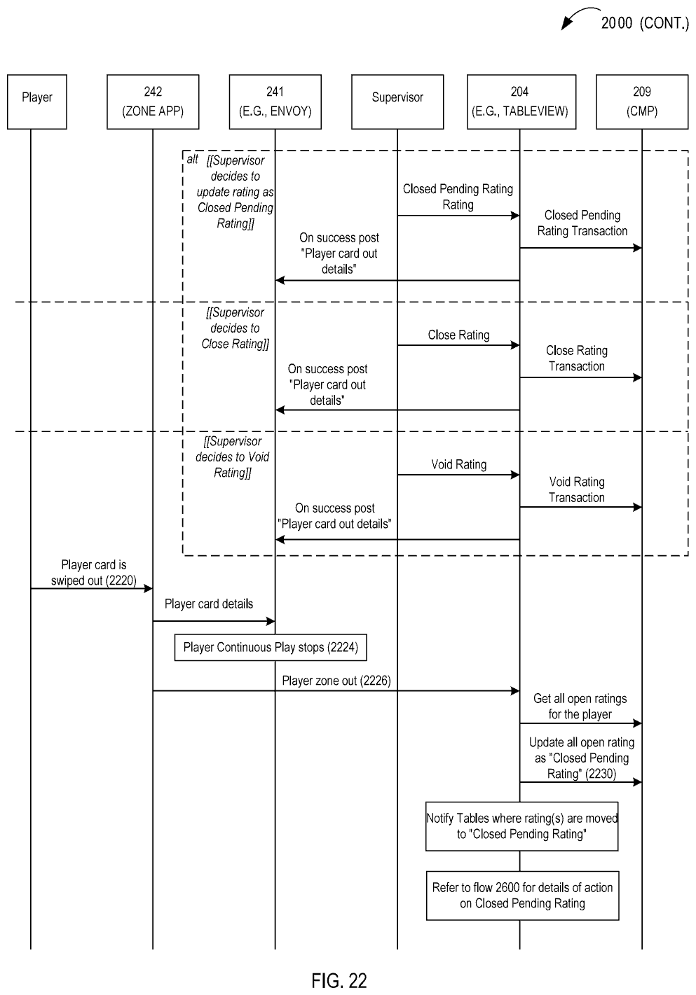

In some embodiments, the gaming platform system 240 performs a player rating transactions in a zone configuration (e.g., see flow 2000 in FIG. 20, FIG. 21, and FIG. 22). For example, player break time tracking starts (2006) as soon as player enters the zone (2008), by swiping into the zone app (2002). The player break time tracking stops (2224) when player exits the zone (2220, 2226). The player's break time tracking is not dependent on rating(s) opened in table management system 204. A player can have multiple ratings in a zone. If the player exits the zone (2226), without any open ratings being closed, all the open ratings are automatically updated as Closed Pending Rating (2230). A supervisor can later review them and close or void these ratings.

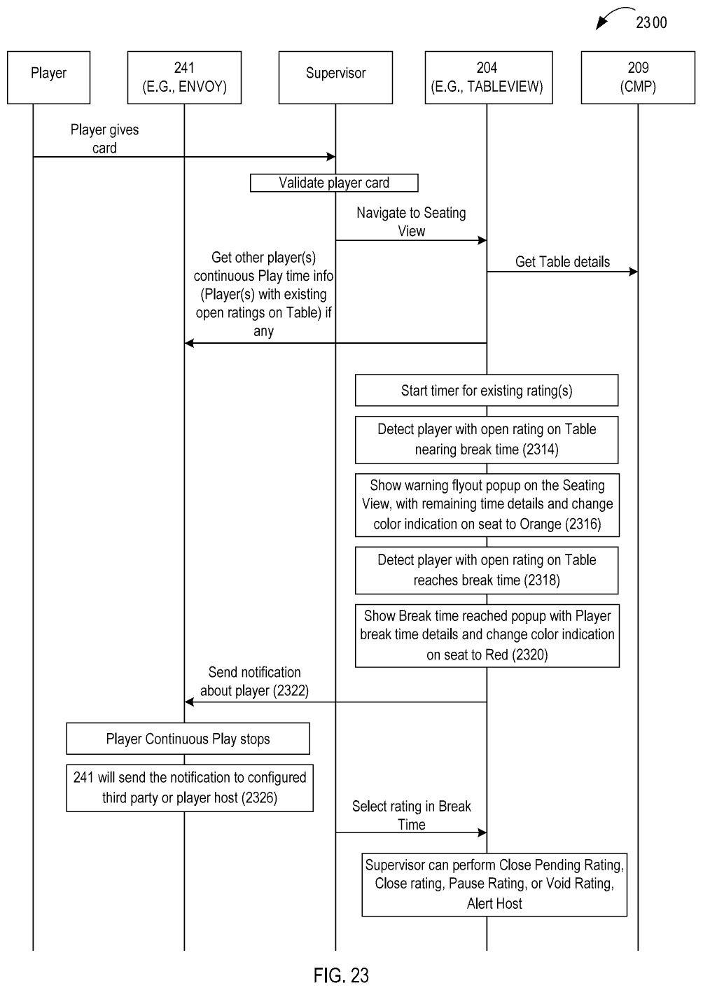

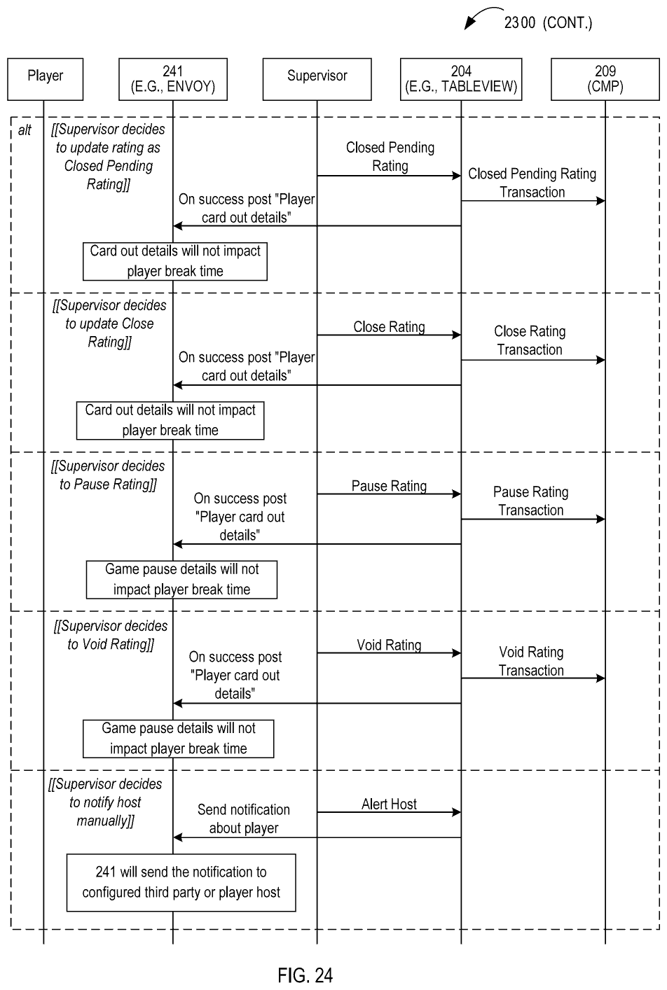

In some embodiments, the gaming platform system 240 manages a play session when a player that has an open rating is nearing (2314) and/or reaches a break time (2318) (e.g., see flow 2300 in FIG. 23 and FIG. 24). The table management system 204 can notify (2322) the gaming platform system 240 and an automatic notification is sent to configured third party apps and host (2326) by gaming platform system 240 (via third-party management application 241). The table management system 204 indicates this by showing a popup (2316, 2320) and changing a color associated with a player station (e.g., a seat of the player at a gaming table).

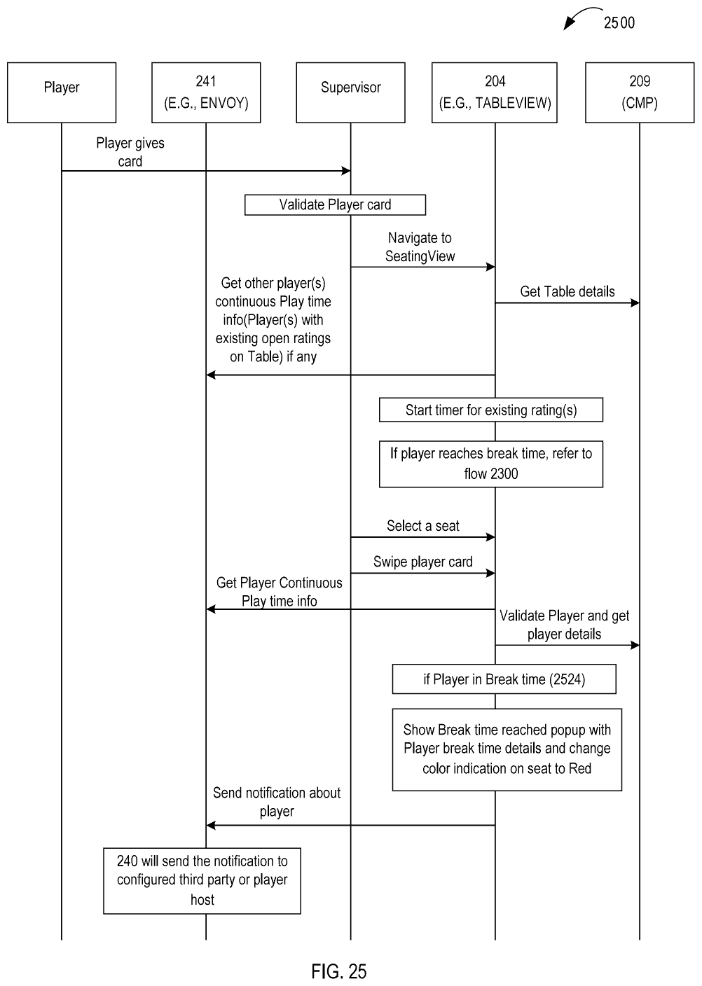

In some embodiments, the gaming platform system 240 restricts an opening of a rating when a player is in a break time (e.g., see flow 2500 in FIG. 25). A player already in break time (2524) is not allowed to open a rating in table management system 204. In some embodiments, restricting an opening of a rating when a player is in a break time is the same for MGF and zone ratings.

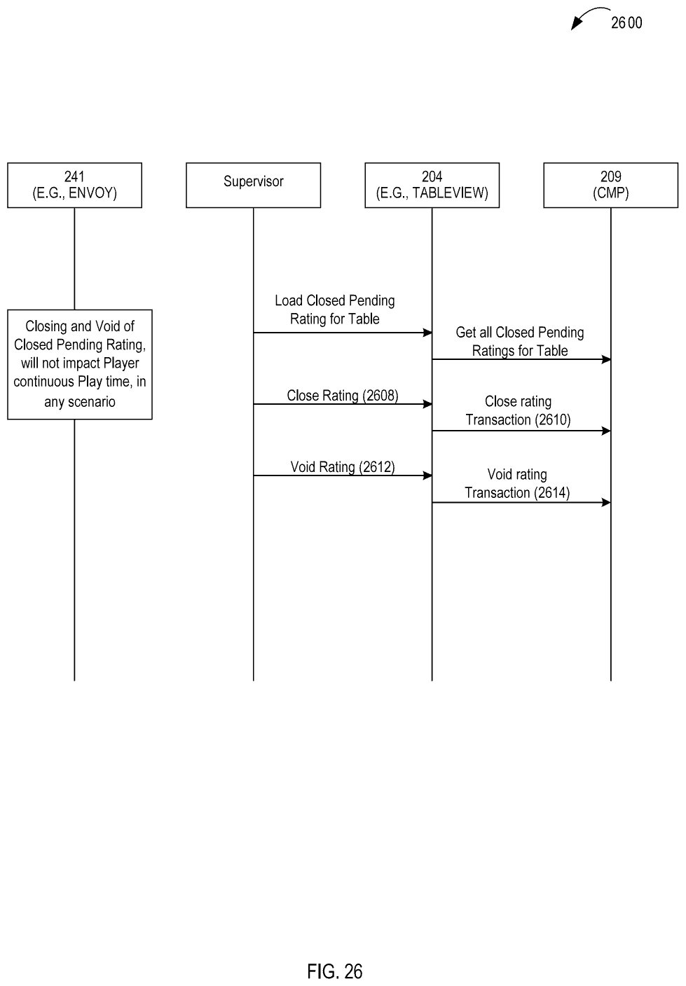

In some embodiments, the gaming platform system 240 provides options for a supervisor to review and close or void a closed pending rating (e.g., see flow 2600 in FIG. 26). For example, a closed pending rating can be reviewed and closed (2608, 2610) or voided (2612, 2614) by supervisors. In some embodiments, reviewing, closing, and/or voiding a closed pending rating is the same for MGF and zone ratings.

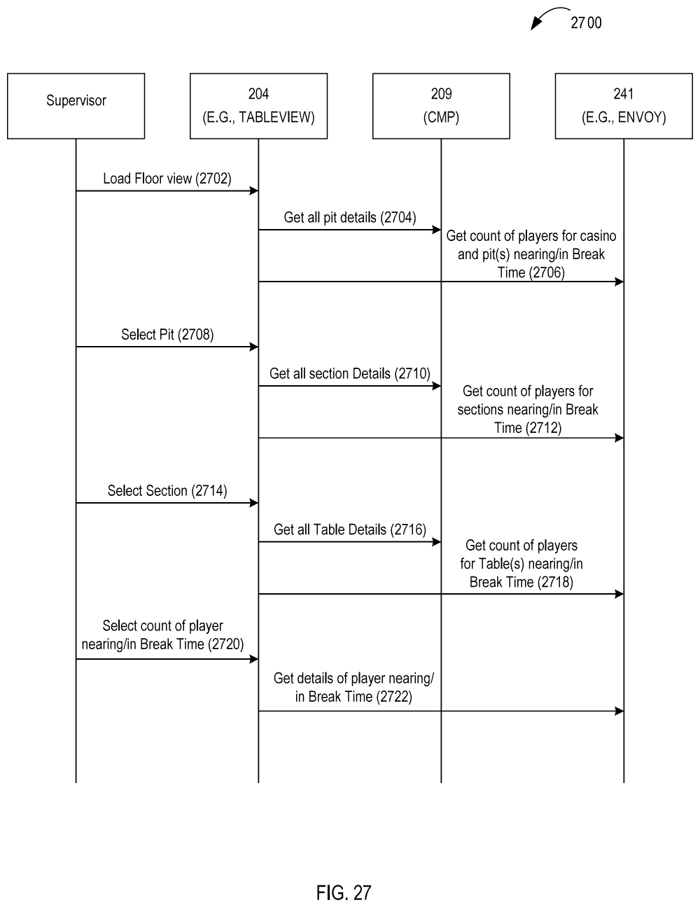

In some embodiments, the gaming platform system 240 provides options for a pit manager to navigate to a floor view (e.g., see flow 2700 in FIG. 27). For example, a pit manager, or any other user with required access can view an overall count and details of players nearing a break time, or who are in break time (2706, 2712, 2718, 2722) (e.g., both for MGF and zone). In some embodiments, the information is made available at casino, pit, section and table levels (2702, 2704, 2708, 2710, 2714, 2716, 2720).

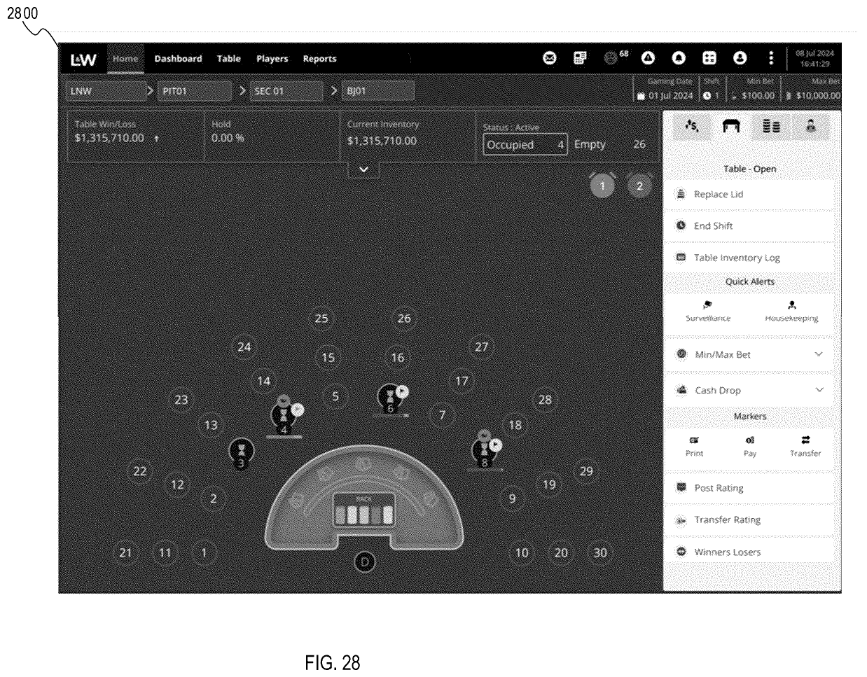

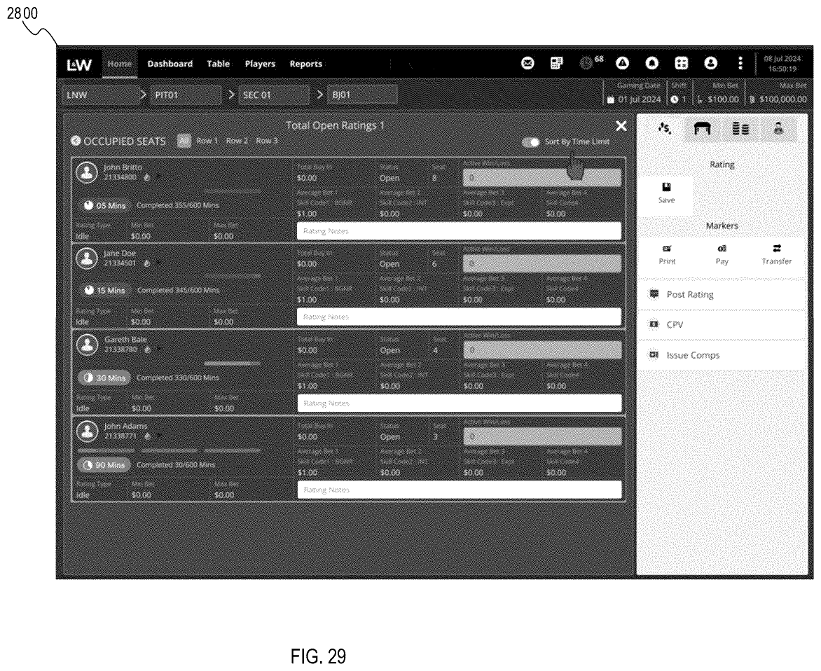

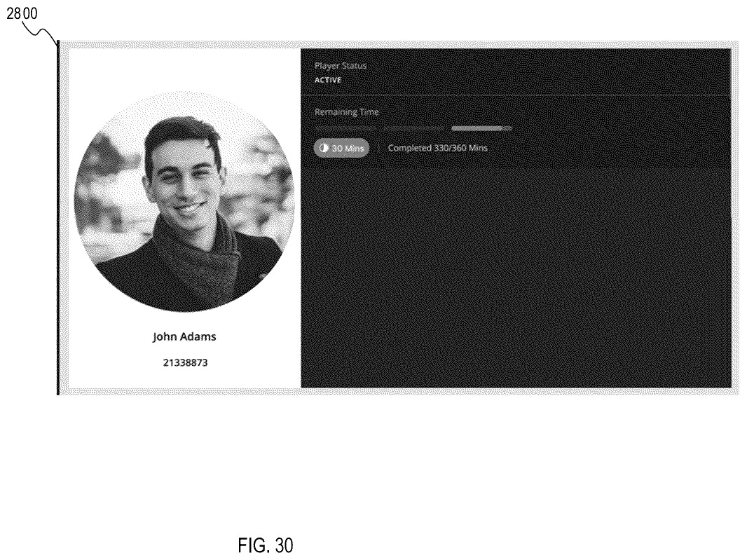

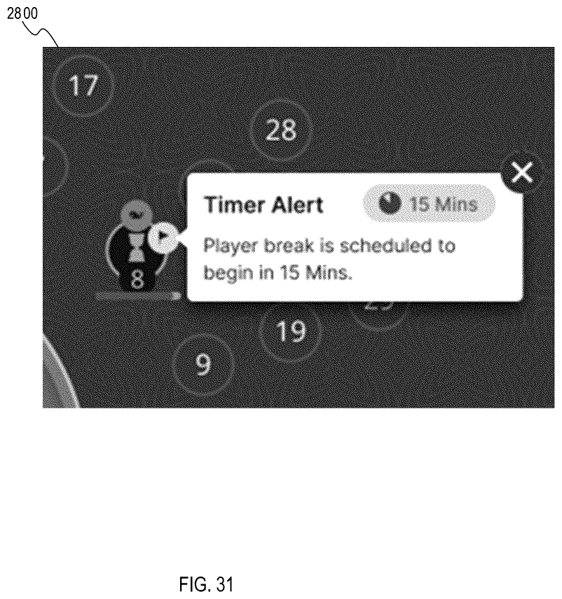

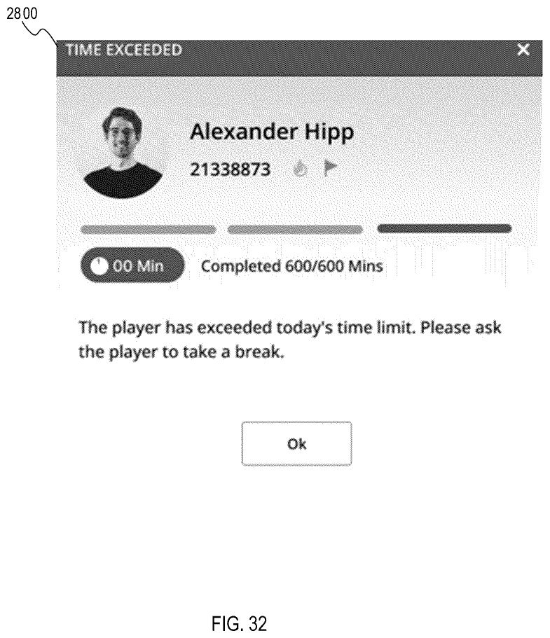

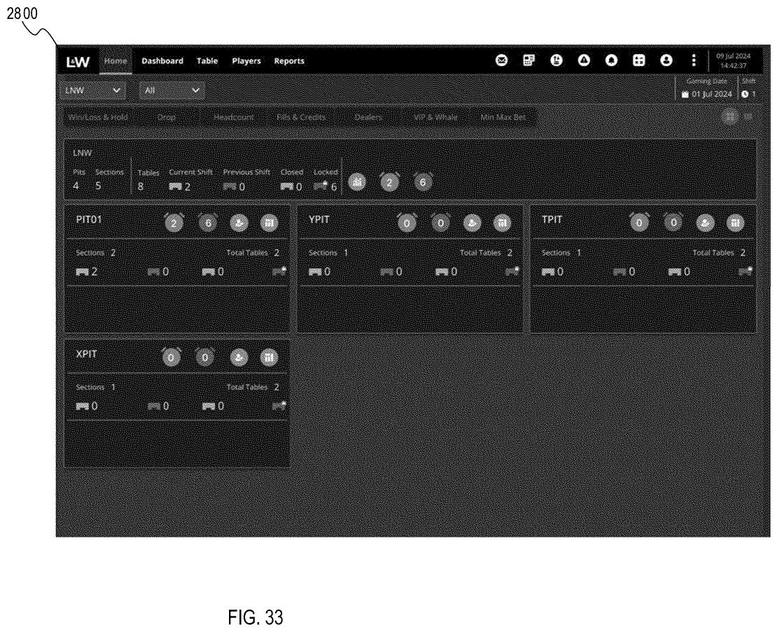

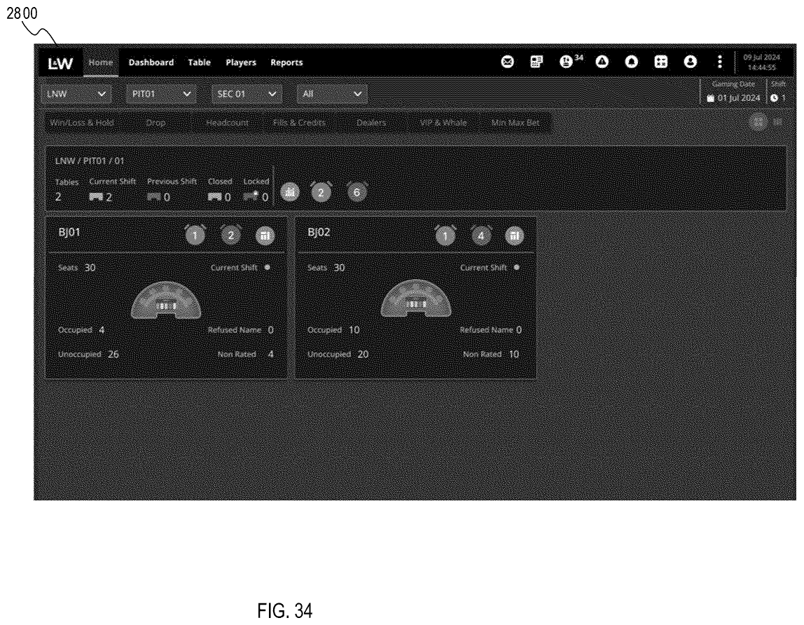

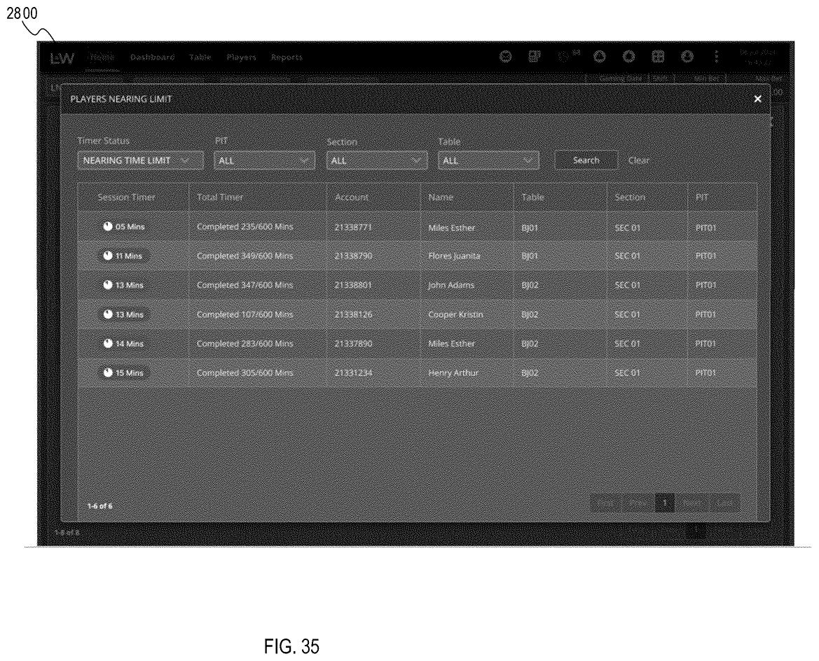

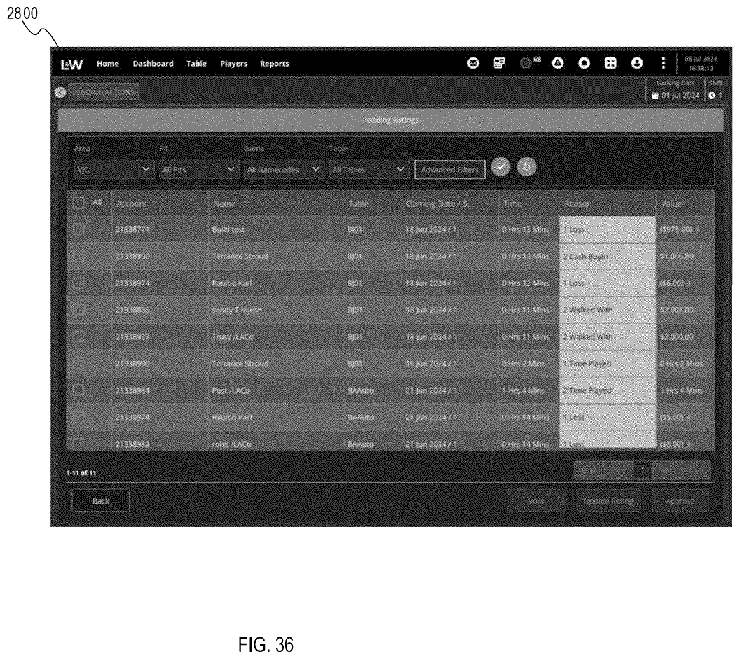

FIG. 28 through FIG. 36 illustrate some examples of screens presentable via a user interface 2800 presented via the table management system 204. FIG. 28 illustrates an example seating view. FIG. 29 illustrates an example seating view showing occupied seats at a gaming table(s) 203 as sorted by a time limit. FIG. 30 illustrates an example view of player details that appear when a rating is opened. FIG. 31 illustrates an example view of a flyout and bar color change when a player is nearing a break time. FIG. 32 illustrates an example of a popup and bar color change when a player reaches a break time. FIG. 33 illustrates an example floor view showing casino and pit level counts of players nearing a break and/or who are in break time. FIG. 34 illustrates an example floor view showing a section and table level count of players nearing a break and/or who are in break time. FIG. 35 illustrates an example view of player details shown when a count is selected. FIG. 36 illustrates an example view of ratings in a close pending state.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and with all other features in all other documents incorporated by reference, without limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
performing, by a processor based on user input associated with a player interface device at a player station of a gaming table, a mandatory login of a player account, wherein the mandatory login initiates a gaming session for the player account at the player station;
tracking, by the processor, player activity, wherein at least a portion of the player activity occurs during the gaming session;
detecting, by the processor based on the tracked player activity, that a threshold is exceeded for a responsible gaming restriction;
automatically modifying, by the processor based on the exceeded threshold, one or more gaming states at the gaming table for a given period;
indicating, by the processor via the player interface device, a progressing status associated with the given period; and
restoring, by the processor in response to expiration of the given period, the one or more gaming states.

2. The method of claim 1, wherein the tracking comprises:
tracking, by the processor, the player activity for gaming activity performed by the player account over a past period prior to the gaming session;
segmenting, by the processor via a machine learning model based on the player activity over the past period and based on the at least a portion of the player activity that occurs during the gaming session, one of a plurality of levels for a player risk behavior associated with the responsible gaming restriction; and
selecting, by the processor based on the one of the plurality of levels, a level of modification of the one or more gaming states.

3. The method of claim 2, wherein selecting the level of modification comprises selecting an intervention strategy from a plurality of types of intervention strategies that correspond respectively to the plurality of levels for the player risk behavior.

4. The method of claim 3, wherein at least one of the plurality of types of intervention strategies includes a mandatory break in play for a given break time, wherein automatically modifying the one or more gaming states comprises disabling at least one gaming function associated with the player station during the given period, and wherein restoring the one or more gaming states after the expiration of the given period comprises re-enabling the at least one gaming function.

5. The method of claim 1, wherein the indicating the progressing status associated with the given period comprises modifying a visual indicator on a display of the player interface device to signify a change of status related to a timing for the responsible gaming restriction over the gaming session in relation to the given period.

6. The method of claim 5, wherein the modifying the visual indicator comprises:
presenting, via the player interface device prior to automatically modifying the one or more gaming states, one or more first colors to indicate a non-restricted game play prior to the given period;
presenting, via the player interface device after automatically modifying the one or more gaming states, at least a second color to indicate restricted game play for the given period; and
presenting, in response to the expiration of the given period, the one or more first colors.

7. The method of claim 6, wherein the presenting the one or more first colors comprises presenting a set of first colors that indicate different stages of the non-restricted game play, where a first of the set of first colors indicates availability of the player station prior to the mandatory login and a second of the set of first colors indicates that a state associated with the restricted game play is approaching.

8. The method of claim 1, wherein detecting that the threshold is exceeded for the responsible gaming restriction comprises detecting that a customized threshold associated with the player account is more strict than a threshold associated with one or more of a jurisdictional restriction or a casino operator restriction, and wherein the automatically modifying the one or more gaming states is based on the customized threshold being exceeded.

9. The method of claim 1, wherein the performing the mandatory login comprises:
performing, via a near-field communication (NFC) device enclosed in the player interface device, an NFC connection between the player interface device and an NFC-enabled mobile device positioned within a given proximity to the player interface device;
obtaining, via the NFC connection in association with a mobile application running on the mobile device, information about the player account; and
performing the mandatory login using the information about the player account.

10. The method of claim 9, wherein the mobile application is a digital wallet, and wherein obtaining the information about the player account comprises obtaining at least one of a player identifier or a casino loyalty account identifier stored in electronic wallet application, and wherein performing the mandatory login comprises logging into the player account, via a casino network, using the at least one of the player identifier or the casino loyalty account identifier.

11. The method of claim 1 further comprising: tracking player betting activity at the gaming table via a Table Event Aggregator (TEA) Service that captures events in real-time, wherein the tracked player activity comprises the tracked player betting activity.

12. A gaming system comprising:
a memory configured to store instructions associated with a gaming table; and
a processor, wherein the processor is configured execute the instructions, which when executed cause the gaming system to perform operations to:
perform, in response to user input received via a player interface device at a player station of the gaming table, a mandatory login of a player account, wherein the mandatory login initiates a gaming session for the player account at the player station;
track player activity associated with the player account, wherein at least a portion of the player activity occurs during the gaming session;
detect, based on analysis of the tracked player activity, that a threshold is exceeded for a responsible gaming restriction;
automatically modify, based on the exceeded threshold, one or more gaming states at the gaming table for a given period;
indicate, via the player interface device, a progressing status associated with the given period; and
automatically restore, in response to expiration of the given period, the one or more gaming states.

13. The gaming system of claim 12, wherein the processor is configured to execute instructions that, when executed, cause the gaming system to perform operations to:
track, the player activity for each game play performed by the player account over a past period prior to the gaming session;
segment, via a machine learning model based on the player activity over the past period and based on the at least a portion of the player activity that occurs during the gaming session, one of a plurality of levels for a player risk behavior associated with the responsible gaming restriction; and
select, based on the one of the plurality of levels, a level of modification of the one or more gaming states.

14. The gaming system of claim 13, wherein selection of the level of modification comprises selection of an intervention strategy from a plurality of types of intervention strategies that correspond respectively to the plurality of levels for the player risk behavior.

15. The gaming system of claim 14, wherein at least one of the plurality of types of intervention strategies includes a mandatory break in play for a given break time, wherein modification of the one or more gaming states disables at least one gaming function associated with the player station during the given period, and wherein the processor configured to automatically restore the one or more gaming states is configured to execute instructions that cause the gaming system to perform operations to re-enable the at least one gaming function after the expiration of the given period.

16. The gaming system of claim 12, wherein the processor configured to execute instructions that, when executed, cause the gaming system to indicate the progressing status associated with the given period is configured to execute instructions that, when executed, cause the gaming system to perform operations to modify a visual indicator on a display of the player interface device to signify a change of status related to a timing for the responsible gaming restriction over the gaming session in relation to the given period.

17. The gaming system of claim 16, wherein modification of the visual indicator on the display comprises presentation of a first color to indicate non-restricted game play and presentation of a second color to indicate restricted game play.

18. An apparatus comprising:
a memory storing instructions; and
a processor configured to execute the instructions to:
track player activity associated with a player account during a gaming session;
input the tracked player activity into a machine learning model;
receive, from the machine learning model, a player segmentation label based on a detected player risk behavior; and
trigger a personalized intervention strategy corresponding to the player segmentation label.

19. The apparatus of claim 18, wherein the personalized intervention strategy is selected from a plurality of intervention strategies, wherein each strategy corresponds to a different player segmentation label.

20. The apparatus of claim 19, wherein the plurality of intervention strategies includes at least one of a soft intervention and a hard intervention, wherein the soft intervention comprises sending a message to a player interface device, and the hard intervention comprises enforcing a mandatory break in play.
